(19) United States
(12) Patent Application Publication
(10) Pub. No.: US 2005/0260865 A1
(43) Pub. Date: Nov. 24, 2005

(54) Connector and the methods of use thereof

(76) Inventor: Jurg A. Rehbein, New York, NY (US)

Correspondence Address: JONES DAY, 222 EAST 41ST ST, NEW YORK, NY, 10017, US

(21) Appl. No.: 11/102,747

(22) Filed: Apr. 8, 2005

Related U.S. Application Data
(60) Provisional application No. 60/572,671, filed on May 19, 2004.

(51) Int. Cl. H01R 39/00

(52) U.S. Cl. 439/15

(57) ABSTRACT

A connector is disclosed which allows standard hardware pieces (e.g. hinges, etc.) to be easily connected to round or other substantially non-planar surfaces or surfaces with minimal planar aspects. Currently, direct connection of standard hardware to round or other substantially non-planar surfaces is cumbersome, or not practical or possible since existing hardware is generally configured to attach only to planar surfaces. The connector comprises a first surface configured to engage the non-planar structure and second surface configured to engage the planar surface of the standard hardware piece (e.g. a hinge). The disclosed connector may be installed using the same tools used to install standard hardware, such as wrenches or screw drivers, socket drivers, etc. The connector may integrate a standard hardware piece, or it may be configured to attach to a separate standard hardware piece. Either way, the connector may be used, for example, to attach doors, side panels etc. to open shelving units that use round pipe or tubing as vertical supports. The connector expands the uses of currently limited standard hardware pieces, to allow connection to a wider range of structural surfaces.

### TECHNICAL FIELD

The present invention relates to connecting hardware, and more particularly, to a connector that can be used to easily allow the connection of standard hardware pieces to non-planar surfaces.

### BACKGROUND OF THE INVENTION

The invention relates to a connector that allows a user to easily connect standard hardware pieces (e.g. hinges, plates, panels, door latches, clip-on fasteners etc.) to non-planar surfaces or to surfaces having minimal planar aspects. Standard hardware pieces are generally configured to facilitate the connection of two planar surfaces (e.g. hingedly connecting a door to a doorjamb, connecting a door and a side wall, to connect the latch of a door knob to one surface, and a corresponding dash plate to a second surface). However, such standard hardware pieces are of little use in connecting substantially non-planar surfaces (e.g. hingedly connecting a door to a pipe, tube, or angle member), nor are these pieces standard pieces of use in connecting planar or substantially non-planar surfaces to surfaces having minimal planar aspects (e.g. angle or box beam members having planar dimensions so small that standard hardware is unable, either due to fastener size or to the position of the fastener holes, to engage the planar member). Need for such connections exists for users of open structures such as shelving units, room dividers, store installations etc. who would like to easily enclose such structures using standard panels, walls, sliding doors, or other types of enclosures. Because these open structures typically are constructed of small round or square tubular members, of “L” or “T” shaped extrusions or forgings having small planar surfaces, or of other complex shapes having little or no planar surfaces, standard hardware pieces are unsuitable for providing the desired connections. Another example in which standard hardware pieces alone are impractical for use is when attaching doors etc. to large concave or convex surfaces.

Further, even if it were possible to modify existing hardware to attach to such structures, drilling into the structure to establish the holes necessary for the installation of screws or bolts may in some cases be problematic. Besides being cumbersome, if the structure bears heavy loads, drilling may not be advisable because it could unacceptably weaken the structure. In such cases, welding or brazing may be preferred. To address these applications, the connector may be configured to allow welding or brazing of the connector to the structure.

Once the connector is affixed to the non-planar structure, the appropriate enclosure members (e.g. cabinet walls, doors) may easily be mounted to the connector's planar surface. Standard hardware pieces may also be mounted to the connector's planar surface.

The connector is also aesthetically pleasing, since it may be ideally shaped to conform to the non-planar surface to which it attaches.

Therefore, there is a need in the art for hardware that will enable a user to easily connect standard hardware to a wide variety of non-planar surfaces, or short planar surfaces for which standard hardware is simply to large to connect.

### SUMMARY OF THE INVENTION

The present invention provides a connector for connecting a first element to a second element, the connector comprising a first surface for connecting to the first element and having a first locking member, and a second surface for connecting to the second element and having a second locking member. The first element may be substantially planar and the second element may be substantially non-planar. The first surface may be configured to engage-the first element and the second surface may be configured to engage the second element, the first locking member configured to lock the first surface to the first element and the second locking member configured to lock the second surface to the second element. The connector second surface may have a round or oval cross-section, and the connector first surface has at least one planar aspect.

The connector may further comprise at least a third surface associated with, and non-coplanar to, the first surface, wherein the third surface may be configured to engage a third planar element. The third surface may comprise at least one locking member configured to engage the third surface with the third element. The connector first surface may have a square, rectangular, or triangular cross-section. The first locking member comprises at least one recess configured to receive a fastener. The second locking member may comprise at least one clamp configured to engage the second element.

The first locking member may comprise at least one recess configured to receive a fastener to connect the first surface to the first element, and the second locking member may be configured to engage the second element. The second locking member may comprise at least one clamp, and the clamp may comprise at least one threaded rod having an actuation end and a clamping end. The actuation end may comprise an actuator and the clamping end may have an associated clamping face, the first and second faces may comprise a wall therebetween, the wall having a threaded bore configured to receive the threaded rod between its actuation and clamping ends, the clamping face disposed between the first and second surfaces, wherein rotation of the at least one threaded rod in a first direction may cause the associated clamping face to extend toward the second element to engage the second element, and rotation of the at least one threaded rod in a second direction may cause the associated clamping face to retract from the second element.

The second element may have a cross-section selected from the group of round or elliptical. The connector first surface may further comprises a hinge member having at least one recess for receiving a fastener, and the first locking member may comprise at least one recess configured to accept a fastener, the first locking member recess may be further configured to correspond with the recess in the hinge member, so that when the hinge member engages the connector and the hinge and locking member holes are aligned to permit insertion of a fastener therethrough, tightening the fastener fixes the hinge member to the connector.

The connector first surface may further comprise a recess configured to releasably engage a tongue latch of a door so that engagement of the tongue-latch and the recess connects the connector to the door. The second surface may comprise first and second halves connected by a hinge, the first and second halves configured to assume a first unlocked position and a second locked position, wherein configuring the halves in the unlocked position allows the second element to be placed between the halves, and configuring the halves in the locked position engages the second element, coupling the second surface to the second element. Configuring the first and second halves in the locked position may substantially prevent relative movement of the first and second halves.

At least one fastener may be disposed within a wall of at least one of the first and second halves, so that when the halves are configured in the locked position, the fastener may be activated to engage the second element to prevent relative movement of the connector and the second element. At least one fastener disposed may be disposed between, and operatively associated with, the first and second halves, such that tightening the fastener configures the halves to the closed locked position. A hinge may further be associated with the first surface, and the hinge may comprise a hinge face having at least one recess configured to accept a fastener for connecting the hinge face to the first element. The connector first surface may further comprise a plurality of threaded and unthreaded holes, slots or other recesses, configured to allow the installation of a variety of first element having different locking element arrangements.

A second connector may be provided for connecting a third element to a fourth element, the connector comprising a third surface for connecting to the third element, and having a third locking member, a fourth surface for connecting to the fourth element, and having a fourth locking member. The third element may be substantially planar and the fourth element may be substantially non-planar, the third surface configured to engage the third element and the fourth surface configured to engage the fourth element, the third locking member configured to lock the third surface to the third element and the fourth locking member configured to lock the fourth surface to the fourth element. At least one support member my be provided having first and second ends and a drawer having at least a first side, having a guide, wherein when the connector is associated with the support member first end, the second connector may be associated with the support member second end, and wherein the support member may comprise an engaging surface configured to receive the guide. The connector, support member, second connector may comprise a unitary piece.

A connector may be provided comprising at least a second connector for connecting a third element to a fourth element. The connector may comprise a third surface for connecting to the third element, and having a third locking member, a fourth surface for connecting to the fourth element, and having a fourth locking member. The third element may be substantially planar and the fourth element may be substantially non-planar, the third surface configured to engage the third element and the fourth surface configured to engage the fourth element. The third locking member may be configured to lock the third surface to the third element and the fourth locking member may be configured to lock the fourth surface to the fourth element. At least one sliding drawer assembly may be provided comprising a drawer and first and second opposing slide members; and first and second vertical non-planar support members. The first surface of the connector may be configured to engage the first opposing slide member, the second surface of said connector may be configured to engage the first support member, the third surface of the second connector may be configured to engage the second opposing slide member, and the fourth face of the second connector may be configured to engage with the second support member.

A connector may further be provided with at least a second connector for connecting a third element to a fourth element, the connector further comprising a third surface for connecting to the third element, and having a third locking member, a fourth surface for connecting to the fourth element, and having a fourth locking member. The third element may be substantially planar and the fourth element may be substantially non-planar, the third surface configured to engage the third element and the fourth surface configured to engage the fourth element, the third locking member configured to lock the third surface to the third element and the fourth locking member configured to lock the fourth surface to the fourth element. At least one shelf may be provided having first and second ends, wherein the connector may be formed integrally with the first end of the at least one shelf and the second connector may be formed integrally with the second end of the at least one shelf.

The connector may be provided with a second locking member comprising a wedge member having a cone-shaped outer surface with a bottom lip and an inner surface comprising at least one projection. The connector second surface may comprises a cone-shaped inner surface configured to engage the wedge member outer surface, and the second element may comprise at least one recess configured to engage the wedge member projection, so that when the wedge member inner projection is engaged with the second element groove the wedge member is configured in a locked position with respect to the second element. Further, when the connector second surface engages the wedge member outer surface the lip maintains the position of the connector in a first direction along the second element. The lip may comprise an annular rim element configured to contact a lower surface of the connector second surface. A hinge may be associated with the first surface. The first surface may also comprise at least one recess configured to receive a fastener.

A connector for connecting a hardware member to a structural member may be provided, the connector comprising a first surface for connecting to the hardware member, and having a first locking member, and a second surface for connecting to the structural member, and having a second locking member. The hardware and structural members may be substantially planar and each may have a width. The first surface may be configured to engage the hardware member and the second surface may be configured to engage the structural member, the first locking member configured to lock the first surface to the hardware member and the second locking member configured to lock the second surface to the structural member. The hardware member may have at least one surface dimension that is greater than at least one surface dimension of the structural member. The connector first surface may have a square, rectangular, or triangular cross-section. The first locking member may comprise at least one recess configured to receive a fastener, and the second locking member may comprise at least one clamp configured to engage the structural member. The first locking member may comprise at least one recess configured to receive a fastener to connect the first surface to the hardware member, and the second locking member may be configured to engage the structural member. The second locking member may comprise at least one clamp.

The at least one clamp may comprise at least one threaded rod having an actuation end and a clamping end, the actuation end comprising an actuator and the clamping end having an associated clamping face, the first and second surfaces may comprise a wall therebetween, the wall having a threaded bore configured to receive the threaded rod between its actuation and clamping ends, the clamping face disposed between the first and second surfaces, wherein rotation of the at least one threaded rod in a first direction may cause the associated clamping face to extend toward the structural member to engage the structural member, and rotation of the at least one threaded rod in a second direction may cause the associated clamping face to retract from the structural member.

A connecting system may be provided for attaching at least one planar member to a plurality of non-planar members. The system may comprise at least one planar member having a planar surface, the planar surface having at least first and second portions. A plurality of non-planar members may be provided, each having at least one non-planar surface. A first connector may be provided for connecting the first planar member to a first non-planar member, the first connector may comprise a first face for connecting to first portion of the planar surface, a second face for connecting to the first non-planar surface. A second connector may be provided for connecting the planar member to a second non-planar member, the second connector comprising a first face for connecting to the second portion of the planar surface and a second face for connecting to the second non-planar surface. The first connector may engage respective planar and non-planar members and the second connector may engage respective planar and non-planar members so that the at least one planar member at least partially overlaps the plurality of non-planar members.

The system may comprise first and second connectors each having a hinge with at least one hinge face. The first hinge face may be configured to engage the first portion of the planar surface, and the second hinge face may be configured to engage the second portion of the planar surface.

The system of connectors may further comprise third and fourth connectors and a door panel having first and second ends, the first end having a tongue-latch mechanism. The third connector may comprise a recess configured and arranged to engage the door panel tongue-latch, and the fourth connector first face may comprise a hinge member to connect to the door panel second end, so that when the door panel is in the closed configuration the tongue-latch engages the recess in the third connector and the door panel overlaps at least a portion of the non-planar members.

A system of connectors may be provided for attaching a modular system of perforated members to a plurality of non-planar members comprising at least first and second planar perforated members each having first and second ends and each comprising a plurality of locking members located between said first and second ends. A first connector may be provided for connecting a first element to a second element, the first connector comprising a first surface for connecting to the first element, and having a first locking member, a second surface for connecting to the second element, and having a second locking member. The first element may be substantially planar and the second element may be substantially non-planar. The first surface may be configured to engage the first element and the second surface may be configured to engage the second element. The first locking member may be configured to lock the first surface to the first element and the second locking member may be configured to lock the second surface to the second element. At least a second connector may be provided for connecting a third element to a fourth element. The second connector may comprise a third surface for connecting to the third element, and having a third locking member. A fourth surface may be provided for connecting to the fourth element and having a fourth locking member. The third element is substantially planar and the fourth element may be substantially non-planar, the third surface may be configured to engage the third element and the fourth surface may be configured to engage the fourth element, the third locking member may be configured to lock the third surface to the third element and the fourth locking member may be configured to lock the fourth surface to the fourth element. When the first surface of the first connector is configured to engage at least one locking member of the first perforated member, the first surface of the second connector may be configured to engage at least one locking member of the second perforated member, and wherein the second surface of the first connector is further configured to engage the first non-planar member and the second fourth surface of the second connector may be further configured to engage the second non-planar member to thereby mechanically couple the first and second planar perforated members to the first and second non-planar members. The locking members may be further configured to receive at least one shelf member.

### BRIEF DESCRIPTION OF THE DRAWINGS

The features and advantages of the present invention will become more readily apparent from the following detailed description of the invention in which like elements are labeled similarly and in which:

FIG. 1 is a perspective view of one embodiment of the connector attached to a round pipe, with a first outer surface section of the connector having threaded holes suitable for receiving a butt hinge and a second outer surface section having a slotted recess configured for installation of a side wall member.

FIG. 2 is a perspective view of the connector of FIG. 1, further comprising a top cover.

FIG. 3 is a perspective view of the connector of FIG. 2, in which a butt hinge is installed on the first outer surface section.

FIG. 4 is a perspective view of the connector of FIG. 3, in which a door member is attached to the butt hinge, and a side panel member having a pin-ball connector is positioned for attachment to the second outer surface section slotted recess.

FIG. 5 is a perspective view of the connector of FIG. 4 showing the side panel member attached to the connector.

FIG. 6 is a perspective view of the connector of FIG. 1, showing one of the first or second outer surface sections incorporating a rectangular recess for engaging the tongue-latch of a door assembly, the connector and door assembly configured in the open position.

FIG. 7 is a perspective view of the connector and door assembly of FIG. 6 in which the door is in the closed position.

FIG. 8 is a perspective view of the connector of FIG. 1, showing the connector with a flat top cover configured to for attachment of a top panel member.

FIG. 9 is a perspective view of the connector of FIG. 8 with side and top panels installed.

FIG. 10 is a perspective view of the connector of FIGS. 1-9 in which the hardware has been used to construct an enclosed shelving unit having side, top and back panel members, and a door member with an operating latch.

FIG. 11 is a perspective view of the connector FIG. 1, in which the hardware is hinged to allow direct introduction of the hardware at any desired point along the structural member.

FIG. 12 is a perspective view of the connector of FIG. 11 in its installed position.

FIG. 13 is a perspective view of the connector of FIG. 12 with two perpendicular planar outer surfaces, and a third round outer surface, with one of the planar surfaces providing for attachment of a butt hinge.

FIG. 14 is a perspective view of the connector of FIG. 13 in which the hardware is hinged to allow direct introduction of the hardware at any desired point along the structural member.

FIG. 15 is a perspective view of the connector of FIG. 14 installed on a cylindrical structural member.

FIG. 16 is a perspective view of the connector of FIG. 1, in which the first outer surface section is of sufficient size and configured with two threaded holes to accept a full overlay hinge.

FIG. 17 is a perspective view of the connector of FIG. 16 further showing the full overlay hinge installed and connected to an associated door member.

FIG. 18 is a perspective view of the connector of FIG. 1 in which multiply-configured recesses are provided on both the first and second outer surface sections to enable easy attachment to a variety of exiting hardware pieces.

FIG. 19 is a perspective view of an embodiment of the connector showing a clamping member securing the cylindrical structural member between the clamping member and two perpendicular facets of the connector, and further showing a butt hinge piece installed on an outer surface section of the hardware.

FIG. 20 is a cross sectional view of the connector of FIG. 19.

FIG. 21 is a perspective view of the connector of FIG. 19 in which the hardware is hinged to allow direct introduction of the hardware at any desired point along the structural member, and further showing a butt hinge piece installed on an outer surface section of the connector.

FIG. 22 is a cross section view of the connector of FIG. 21.

FIG. 23 is a perspective, unassembled view of an embodiment of the connector in which the cylindrical structural member comprises an external cone section which engages a corresponding internal cone section of the connector which allows locking the two pieces together axially when the internal cone section is pushed down onto the external cone section.

FIG. 24 is a cross-sectional view of the embodiment of the connector of FIG. 23 in which the cylindrical structural member comprises an external cone section and is engaged with a corresponding internal cone section of the connector to lock the two pieces together axially.

FIG. 25 is a perspective view of the connector of FIG. 23 and 24, further comprising an integral shelf member.

FIG. 26 is a perspective view of the connector of FIG. 2, in which a plurality of connector pieces are used to support a drawer slide assembly.

FIG. 27 is a perspective view of the connector assembly of FIG. 26 in which the drawer is shown in an extended position.

FIG. 28 is a perspective view of the connector assembly of FIG. 27 in which a supporting element is installed between the connector pieces on each side of the drawer.

FIG. 29 is a perspective view an alternate embodiment of the connector assembly of FIG. 28 in which a supporting element is disposed between two pieces of connectors to form one hardware piece.

FIG. 30 is a perspective view of a system of connector pieces used to construct an enclosed shelving unit having a double sliding front door panel configuration.

FIG. 31 is a side elevation view of the system of the connector pieces of FIG. 30, showing the connection details for the double sliding door panel.

FIG. 32 shows a perspective of a shelving unit with perforated metal flats mounted by means of the connector to the round vertical supports of the shelving unit and running parallel to them; on the perforated metal flats a drawer and a door are mounted.

FIGS. 33A and 33B are perspective and top plan views, respectively, of the connector of FIG. 2, without the cylindrical inner member.

FIGS. 34A and 34B are perspective and top plan views, respectively, of the connector of FIG. 2 in which the structural member has a square cross section, and is offset from the center of the connector piece.

FIGS. 35A and 35B are perspective and top plan views, respectively, of the connector of FIG. 2 in which the structural member is an angle member with an L-shaped cross-section, and is off set from the center of the connector piece

FIGS. 36A and 36B are perspective and top plan views, respectively, of an alternate embodiment of the connector of FIG. 2 in which the two planar outer side surface members are connected by a third side surface, such that the external connector shape assumes a triangle when viewed from above.

FIGS. 37A and 37B are perspective and top plan views, respectively, of an alternate embodiment of the connector of FIG. 2 in which the two planar out side surface members are connected by a rounded third side surface.

FIGS. 38A and 38B are perspective and top plan views, respectively, of an alternate embodiment of the connector of FIG. 2 in which there is only one planar outer side surface member, and the remainder of the outer side surface of the connector is rounded, and the connector is also installed on a structural member having an elliptical cross-section.

FIGS. 39A and 39B are perspective and top plan views, respectively, of an alternative embodiment of the connector of FIG. 1 in which there are only two planar outer side surface members, and there is no remainder outer side surface.

FIG. 40 is a top plan view of two connectors of FIGS. 39A and 39B attached to a connecting bar.

FIG. 41 is a top plan view of two connectors of FIGS. 39A and 39B with a connecting bar permanently attached to the connectors to form one piece.

FIG. 42 is a top plan view of four connectors of FIGS. 39A and 39B with the connecting bars of FIG. 41, permanently attached to form one piece.

FIG. 43 is a perspective view of a shelving unit employing the connectors of FIGS. 39A, B through 42.

FIGS. 44A and 45B are perspective and top plan views, respectively, of the connector of FIG. 1 with a shelf bracket attached to it.

FIG. 45 is a perspective view of the shelf bracket of FIGS. 44A and 45B separate.

FIG. 46 is a top plan view of four connectors of FIGS. 44A and 44B with shelf bracket attached to it and a shelf attached to the shelf brackets.

FIG. 47 is a perspective view of a shelving unit employing the connectors with the shelf brackets of FIGS. 44A, B through 46.

FIG. 49 shows a cross-section of the wedge-type arrangement as described in FIG. 23 and FIG. 24 with the addition of two machine screws.

FIG. 50 shows a cross-section of the same arrangement as described in FIG. 53.

FIG. 51 shows a cross-section of the same arrangement as described in FIG. 50 with the exception that the machine screw extends through the structural member 2.

FIG. 52 shows a cross-section of the same arrangement as described in FIG. 51 with the exception that the machine screw is replaced with a clevis pin.

FIG. 53 show a perspective view of the wedge-type arrangement as described in FIG. 23 and FIG. 24 with the addition of a tongue and grove arrangement that prevents the connector from rotating around the structural member.

FIG. 54 shows a cross-section of the same arrangement as described in FIG. 53.

FIG. 55 show a perspective view of locking arrangement with cylindrical insert with a bottom lip that prevents the connector from sliding down the structural member.

FIG. 56 shows a cross-section of the same arrangement as described in FIG. 55.

FIG. 57 shows the cylindrical insert of FIG. 55 with four wedges that make for a tight fit between the connector and the cylindrical insert.

FIG. 58 shows the same connector as in FIG. 2 with four threaded holes ready to accept the receiving part of a vertically adjustable clip on fastener.

FIG. 59 shows a side view of the same receiving part of the clip on fastener of FIG. 58 attached to the connector.

FIG. 60 shows a cross section of FIG. 58 ready to engage the corresponding, horizontally adjustable insert of the clip on fastener enabling the quick attachment of a side panel to the connector.

FIG. 61 shows a perspective view of the same connector bar as in FIG. 29 with two horizontally adjustable inserts of clip on fasteners.

FIG. 62 show the side view of FIG. 61 ready to engage a side panel by means of the corresponding, receiving parts of a clip on fastener.

### DETAILED DESCRIPTION OF THE INVENTION

The connector disclosed herein is discussed with reference to preferred embodiments adapted to connect standard hardware pieces to non-planar surfaces, such as the cylindrical structural members associated with standard open-style shelving units. It should be understood, however, that the invention finds applicability for use in any circumstance in which it is desired to connect planar and substantially non-planar surfaces.

The connector simplifies the attachment of standard hardware (e.g. locks, hinges, catches, spring catches, strikes, clip connectors, modular tracks, etc.) or other surfaces having planar attributes (e.g. panel members, door members drawers etc.), to surfaces for which such standard hardware is ill suited to connect. Such ill-suited surfaces may comprise pipes or tubes having cylindrical attributes, or they may comprise structural box members or angle members which have planar attributes too small to practically allow connection of standard hardware (e.g. small panels, cladding panels, sidings, doors, sliding doors, covers, rooves, etc.).

In this description, the term “standard hardware” shall mean hardware that is designed generically to connect two or more planar surfaces, either rigidly or hingedly. Non-limiting examples of “standard hardware” are plate hinges, brackets, plate reinforcing members and the like.

In general, the connector is configured to at least partially enclose a segment of the substantially non-planar member to whom it is attached. The connector may comprise a first (outside) surface configured to allow easy attachment to standard hardware pieces or panel or door members using typical fastening devices (e.g. screws, bolts, rivets), and a second (inside) surface configured to engage a planar member. The connector may have a unitary inner surface that conforms to the shape of the non-planar member and may simply be slipped over the end of the non-planar member, or it may have a hinged “clam-shell” configuration which closes around the non-planar member (useful where one or both ends of the non-planar member is inaccessible, or where the configuration of the member is such that sliding the connector along the member to the desired location is not possible).

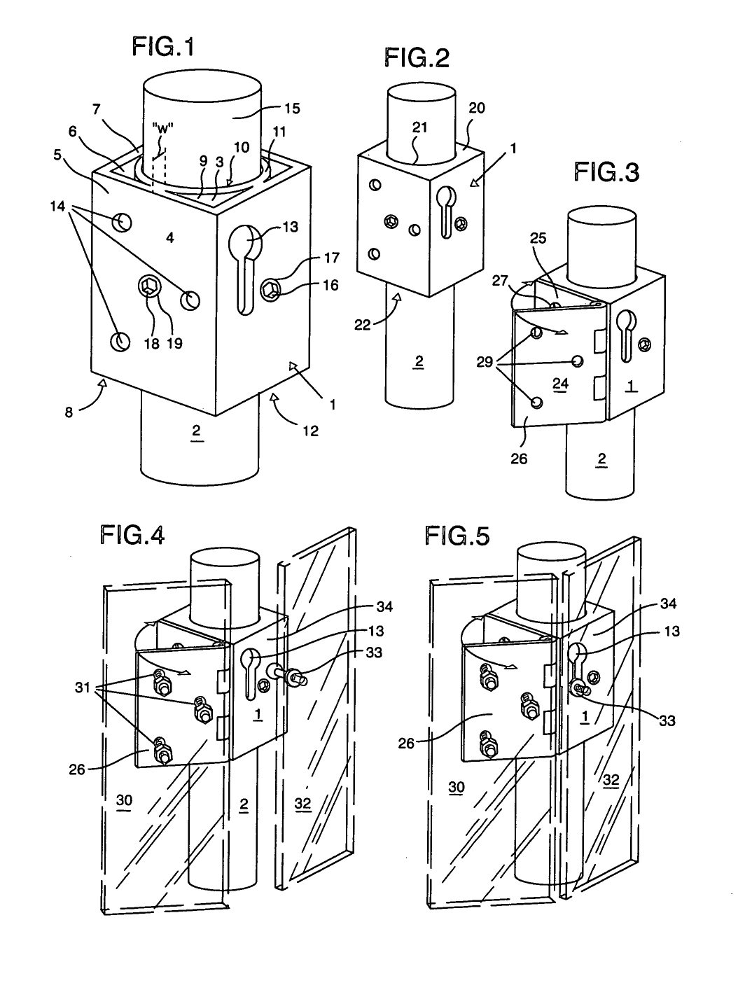

Referring more particularly to the drawings, FIG. 1 shows a perspective view of the adjustable connector 1 installed on a vertical cylindrical member 2. As shown in FIG. 1, the connector 1 may comprise a generally box-shaped exterior surface 4, with flat (planar) outer and inner surfaces 5, 6, with open top and bottom sections 7, 8, and a generally cylindrical inner member 3 having outer and inner surfaces 9, 10 and open top and bottom sections 11, 12. Inner member 3 is configured and sized to conform to the outer surface 15 of the cylindrical member 2, while maintaining sufficient clearance between the two members so that the cylindrical member may slide freely within the inner member 3 to allow positional adjustment of the connector 1 along the cylindrical member 2. Wall “w” lays between the inner member 3 and the exterior surface 4.

The flat outer and inner surfaces 5, 6 each may comprise one or more recesses 13 configured to accept screws, bolts, clips, pins, push-locks, magnetic connectors or any other suitable fasteners, to allow easy connection of standard hardware pieces (e.g. hinges), or flat panels, doors or other similar structural members. For the purposes of this patent the term “recess” shall mean any geometric or volumetric female element (e.g. hole, slot, cavity, threaded hole, key hole, catch, etc.) configured to receive a male fastener element (e.g. rod, threaded rod, screw, machine screw, set screw, strike, pin-and-ball fastener, etc.) Such recesses may have smooth, threaded, ridged or any other surfaces configuration that facilitates connection to and/or retention of a corresponding male fastener element. Likewise, the male fastener elements may have any surface configuration that facilitates connection to a corresponding recess. The connector of FIG. 1 is configured with three pre-drilled threaded holes 14 to allow connection of a standard butt hinge 16 (shown installed in FIG. 3). The cylindrical inner surface member 3 is configured and sized to conform to the outer surface 15 of the cylindrical member 2, while maintaining a minimum clearance (not shown) between the two surfaces to allow the connector to slide freely along the cylindrical member 2 to allow adjustments in connector position.

A pair of setscrews 16, 18 may be disposed in correspondingly threaded through-holes 17, 19 in wall “w.” A user may rotate the setscrews 16, 18 in a first direction to thereby engage the setscrews 16, 18 with the outer surface 15 of the cylindrical member 2. This engagement fixes the connector 1 and the cylindrical member 2 axially and rotationally. Conversely, rotation of the setscrews 16, 18 in a second direction decouples the setscrews 16, 18 from the cylindrical member outer surface 15, thereby decoupling the connector 1 from the cylindrical member 2 to allow the connector to be repositioned or removed.

The connector's inner member 3 and exterior surface 4 may be formed from individual box and cylinder elements of similar or different lengths that are joined using known techniques such as welding, brazing, epoxy, or any other suitable attachment method to yield the unitary piece of FIG. 1. Alternately, the inner member 3 and exterior surface 4 may be formed (e.g. cast, forged, extruded) as a single piece.

The connector 1 may be fabricated of any suitable material known in the art (e.g. metal, plastic, wood), and where the connector 1 is formed from individual box 4 and cylinder 3 members, each member may be fabricated from a different material as appropriate for the intended application.

FIG. 2 is an alternate embodiment of the connector of FIG. 1, in which the top and bottom sections 7, 8 are enclosed. In this embodiment, the connector 1 may comprise a generally cylindrical inner surface member 3 as in the embodiment of FIG. 1, with the addition of at least a top cap 20 having a cylindrical cutout 21 to accept the cylindrical member 2. A bottom cap (not shown) may also be used. Such caps may add structural stability to the connector and may also be more aesthetically pleasing. The connector may incorporate only a top cap, only a bottom cap, or both a top and bottom cap as desired by the user.

Alternatively, the connector 1 of FIG. 2 may comprise an box-shaped, exterior surface 4 having top and bottom caps 20, 22, but without a cylindrical inner member 3. In this embodiment, the cylindrical cut-outs of the top and bottom caps 21, 23 are configured and sized to conform to the outer surface 15 of the cylindrical member 2, while maintaining sufficient clearance between the two surfaces so that the connector may slide freely within the top and bottom caps to allow positional adjustment of the connector 1 along the cylindrical member 2.

FIG. 3 shows the connector of FIG. 2, engaged with cylindrical member 2, in which a standard hardware piece 24 (a “butt hinge”) having first and second hinge faces 25, 26, is attached with screws 27 to one side 28 of the connector's flat outer surface 5. The first hinge face 25 is attached to the flat side 28 of connector 1, while the second hinge face 26 incorporates screw holes 29 configured to accept fasteners (not shown) for attachment to an additional planar surface

FIG. 4 shows connector 1 of FIG. 3, in which a panel member 32 is bolted to the second hinge face 26 of butt hinge 24 using nut and bolt combinations 31. Also shown is a second panel 32, incorporating pin-and-ball fastener 33, being fit-up to slot 13 in the flat side 34 of the flat outer surface 5 of connector 1.

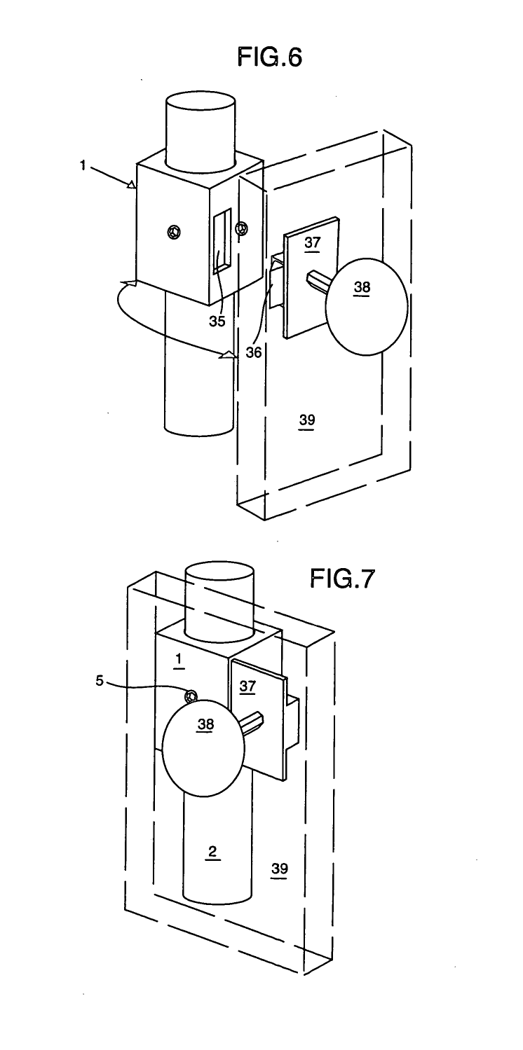

FIG. 5 shows the connector 1 of FIG. 4, in which the second panel 32 is installed on second flat side 34 of connector 1, with a pin-and-ball fastener 33 fully engaged in recess 13. The enlarged ball end of fastener 33 is retained by the reduced width recess 13, thereby preventing the second panel 32 from separating from the connector 1.

FIGS. 6 and 7 show the connector 1 of FIG. 2, engaged with cylindrical member 2, in which the connector 1 incorporates a rectangular recess 35 in flat outer side 34. This recess 35 may be positioned and configured to accept a corresponding tongue portion 36 of a door-latch mechanism 37 which includes a door knob 38 for engaging/disengaging the tongue 36 and recess 35. The door-latch mechanism itself may be attached to a door 39. Alternately, the connector 1 of this embodiment may comprise a second recess (not shown), configured to receive the bolt portion of a dead-bolt locking mechanism, to provide affirmative locking capabilities for the door 39.

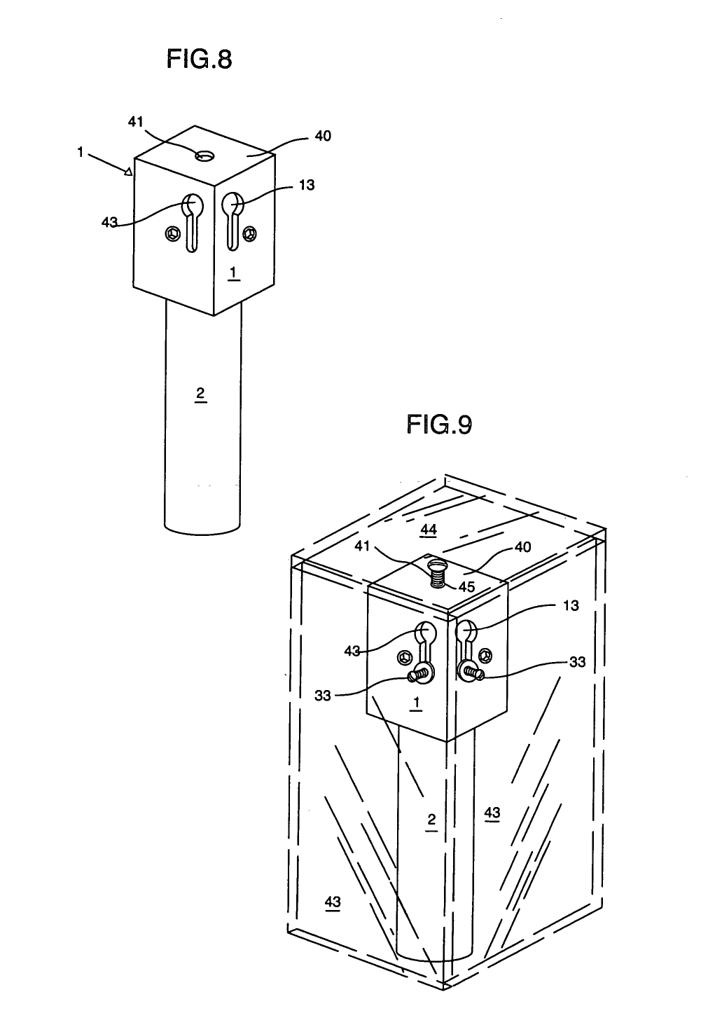

FIG. 8 shows the connector 1 of FIG. 1, further incorporating a solid top cap member 40, which covers the otherwise open end section 7 of connector 1. The inclusion of a top cap 40 requires the connector 1 to be installed on one end of the cylindrical member 2, rather than at an adjustable point along the length of the cylindrical member 2. The cap member 40 of this embodiment may be used either as an axial support for a planar member attached to one of the flat side surfaces 7, 8 or as aesthetic finish to cover the end of the cylindrical member 2. The cap member 40 may have a planar surface to which standard hardware pieces or panels may be attached. As such, cap member 40 may be provided with a threaded hole 41 suitable for accepting a fastener to allow a panel or other planar member to be attached to the top of the cylindrical member 2. Also shown is a recess 42 on the flat outer surface 28.

FIG. 9 shows the connector of FIG. 8, in which side panel members 43 are attached using pin-and-ball fasteners 33 disposed in respective recess 13, 42 of the connector 1 as described above in relation to FIG. 5. In addition, top panel member 44 may be attached to cap 40 using a machine screw 45, which is disposed in threaded hole 41, which in this embodiment is threaded. This arrangement allows easy installation of top, side and/or back panels using the connector I and standard fasteners and panel members.

FIG. 10 shows a system of connectors 1, used to enclose a standard open shelving unit 50 with side 51, top 52 and door 53 panels, door hinge connections 54, and a door knob assembly 55, 56. The arrangement of FIG. 10 is achieved by installing successive levels of shelving 57 and connectors 1 (i.e. from the ground up).

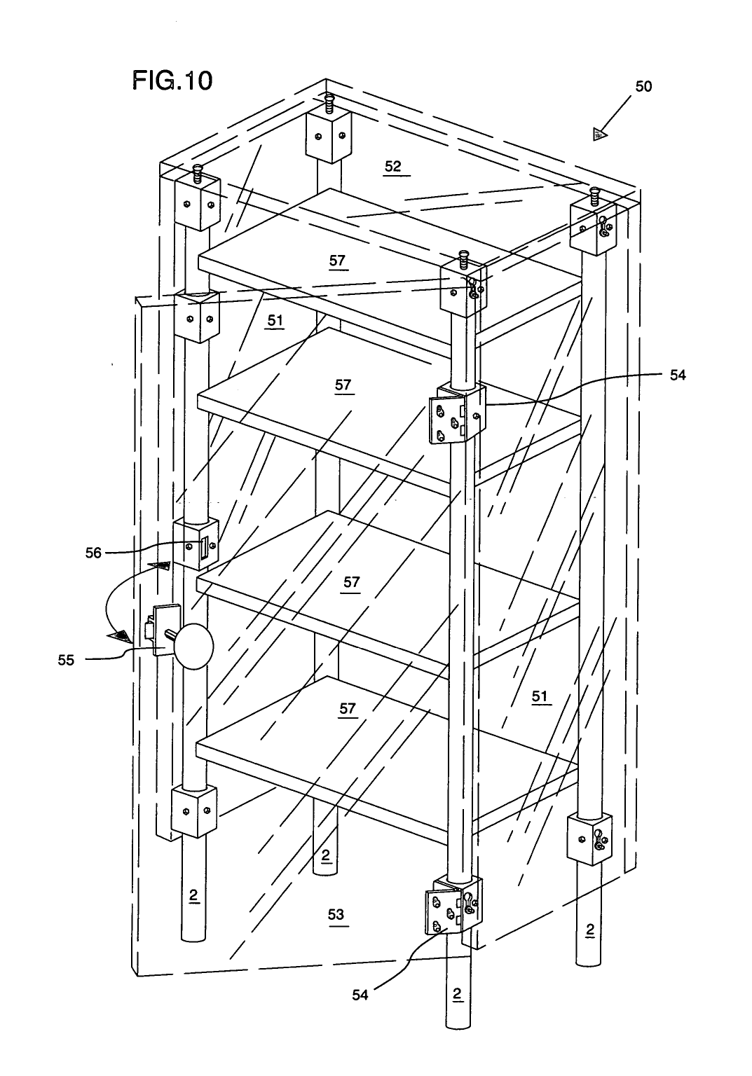

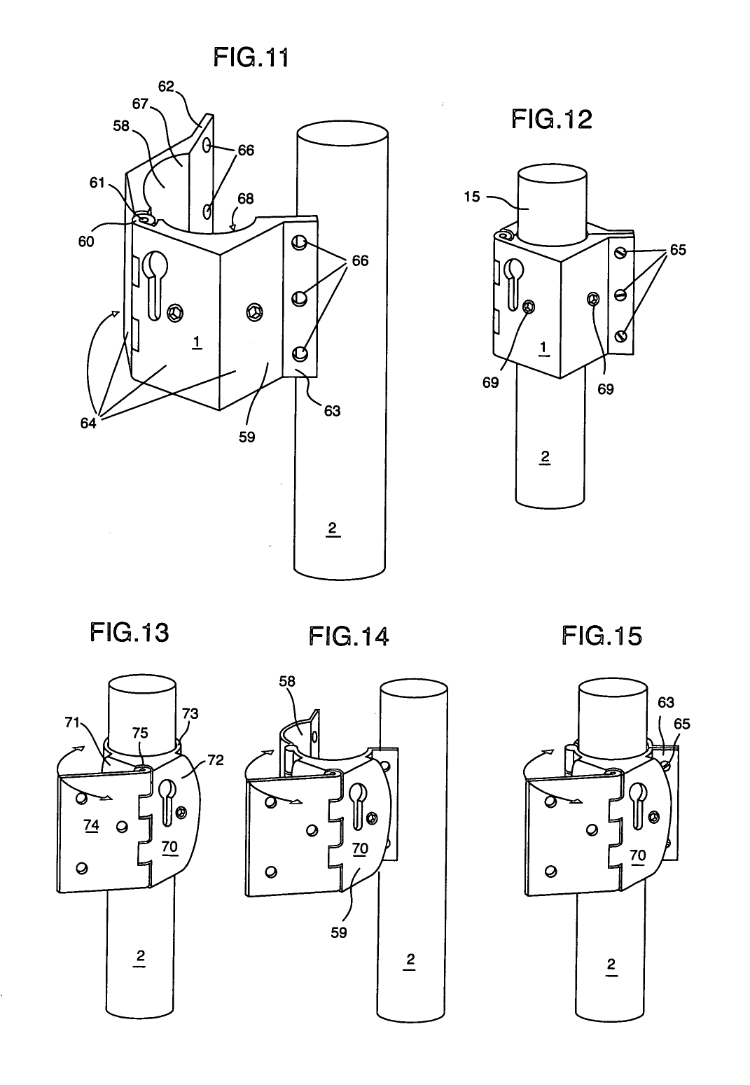

FIG. 11 shows a connector 1 comprising two clamp halves 58, 59 joined by a hinge element 60 having a hinge axis 61. The connector clamp halves 58, 59 are rotatable about the hinge axis 61, so that they may be clamped about the cylindrical structural member 2 at any point on the member. This embodiment is particularly advantageous for instances in which the shelving unit 50 (FIG. 10) has already been constructed, and where it is not possible to place the connector 1 of FIGS. 1-10 over the end of the structural members 2 and to slide it along the member to reach the desired fixation position.

The clamp halves 58, 59 may each comprise a flange section 62, 63 which extend beyond the box shaped outer surface 64 of the clamp halves 58, 59. 62 and 63 mates with each other when the opposing clamp halves 58, 59 close around the structural pipe 2. To close the flange sections 62, 63 may comprise one or more holes 65 suitable for the introduction of fasteners 67, which may be used to maintain the clamp halves 58, 59 locked together about the structural member 2, as shown in FIG. 12.

The connector 1 may be configured so that the clamping force imparted when the clamp halves 58, 59 are locked together maintains the connector 1 and the structural member 2 rotatably and axially fixed together. Alternately, such fixation may be achieved by the use of one or more set screws 69 disposed in the wall “w” of the connector 1, which, when activated, are configured to engage the outer surface 15 of the structural member 2.

The connector halves 58, 59 each may comprise planar outer faces 64 and clamping faces 67, 68 that comprise at least a portion of a cylinder. The clamping face 67, 68 of each half 58, 59 is sized and configured to engage at least a portion of the outer surface 15 of the cylindrical member 2. The planar outer faces 64 are configured with the appropriate recesses to enable easy attachment of side or door panels using standard fasteners such as screws, bolts, pins, etc.

FIG. 12 shows the connector 1 of FIG. 11 where clamp halves 58, 59 are engaging the cylindrical structural member 2, and are locked using machine screws 65 inserted in holes 66.

FIG. 13 shows connector 70, comprising all of the described characteristics of connector 1, with the exception that exterior member 4 has two-planar surfaces 71, 72 oriented perpendicularly with respect to each other, and a round surface 73 connecting them. Integral butt hinge 74 having a hinge axis 75 substantially parallel to the longitudinal axis of cylindrical structural member 2, is provided on planar surface 71. The round surface 73 provides additional clearance on its respective side, which may be preferable when the connector 70 is used in a shelving unit, as it provides for more space on the shelf. It also may be more aesthetically pleasing compared to the box configurations of FIGS. 1-12.

FIG. 14 shows the connector 70 of FIG. 13 with the clamp halves 58, 59 positioned open and ready for installation about cylindrical structural member 2.

FIG. 15 shows the connector 70 of FIGS. 13 and 14 installed about cylindrical structural member 2, and showing flange elements 62, 63 fastened by machine screws 65.

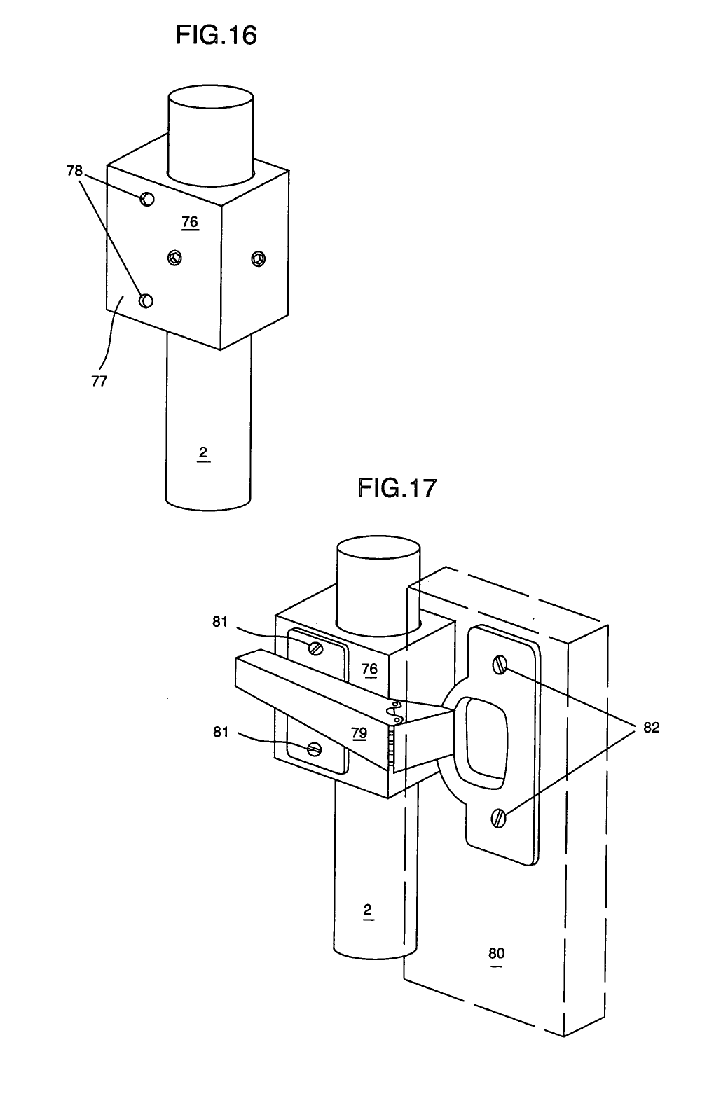

FIG. 16 shows the connector 76, comprising all of the described characteristics of connector 1 of FIG. 1, with the added feature of an enlarged first outer side surface 76, 77 configured with appropriately located and threaded holes 78 suitable for attaching the a full overlay hinge 79.

FIG. 17 shows the connector 76 of FIG. 16 attached to a full overlay hinge 79, which itself is attached to a door panel 80. The overlay hinge 79 is attached to the connector 1 using machine screws 81 that engage threaded holes 78. The overlay hinge 79 is likewise connected to the door panel 80 using machine screws 82.

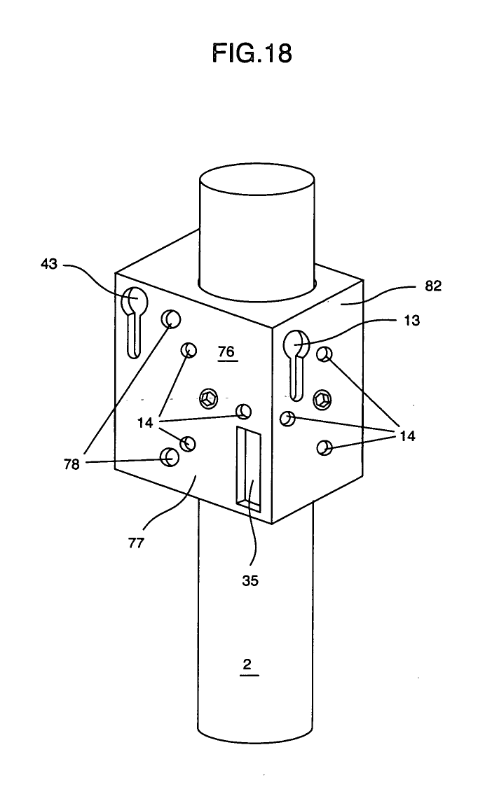

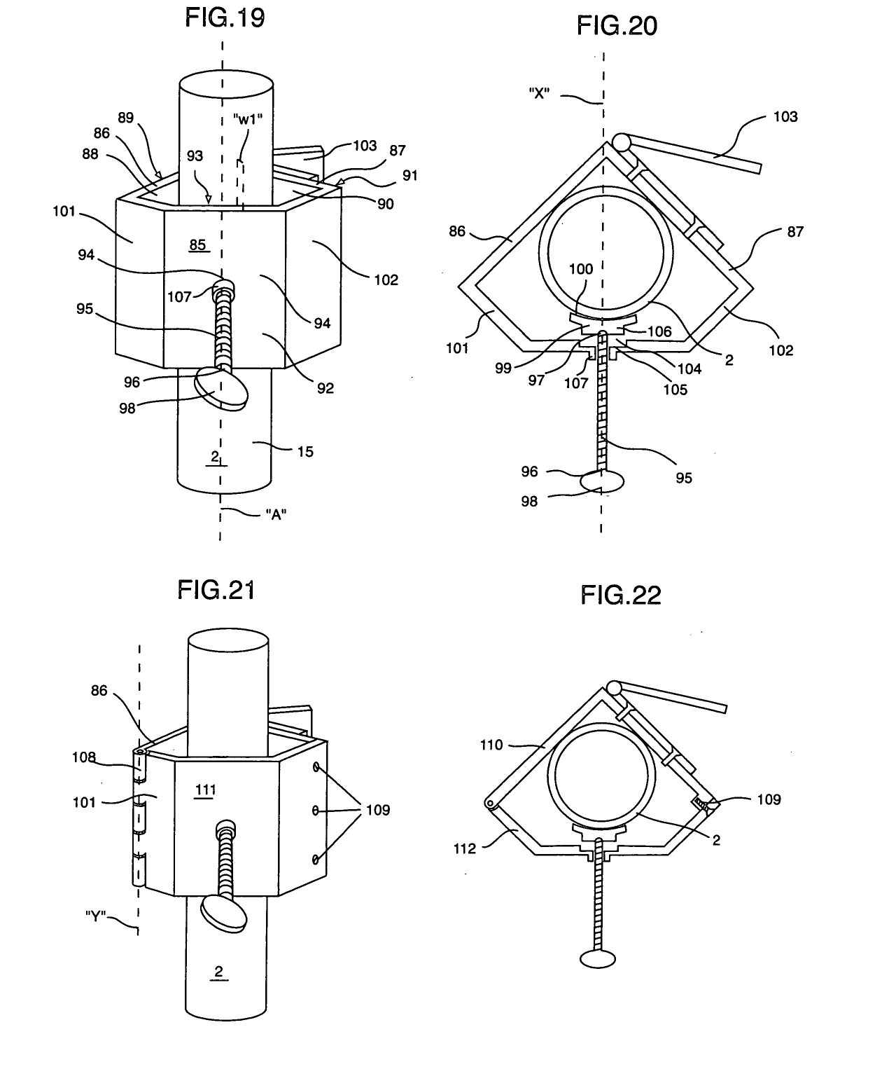

FIG. 18 shows the connector 76 of FIG. 16, incorporating on at least its first and second outer side surfaces 77, 46 variously configured and sized recesses 13, 43 and threaded holes 14, 78 suitable for accepting a variety standard fasteners for attaching a side panel, a full overlay hinge, a butt hinge, or a door-latch mechanism. Threaded holes 17, 19 are suitable for accepting setscrews 16, 18 for use in fixing the connector 76 to the cylindrical member 2. This “universal” embodiment illustrates the potential for using various sizes and configurations of recesses in one connector 76 to allow the attachment of any of various standard hardware pieces or panels to cylindrical member 2.

FIGS. 19 and 20 show an alternative embodiment of the connector 85 mounted on a cylindrical structural member 2. The connector 85 of this embodiment has a longitudinal axis “A” that is substantially parallel to the cylindrical member longitudinal axis. The connector 85 of this embodiment comprises first and second substantially planar members 86, 87, each having substantially planar inner and outer side surfaces 88, 89, 90, 91. The first and second planar members 86, 87 are joined so that their respective outer and inner surfaces 88, 89; 90, 91 are generally oriented perpendicular with respect to each other. It will be appreciated that first and second planar members 86, 87 may also be oriented so that their joinder creates an angle of greater or less than 90 degrees, as appropriate for any particular application. The connector 85 further comprises at least a third substantially planar member 92 having substantially planar inner and outer side surfaces 93, 94 with wall “w1” disposed therebetween. The third planar member's 92 inner and outer side surfaces 93, 94 join the respective inner and outer side surfaces 88, 89; 90, 91 of the first and second members 86, 87 so that the external shape of the connector 85 appears generally triangular when viewed along the connector's longitudinal axis “A.” The third planar member 92 may further comprise at least one threaded hole 94 through wall “w1,” the hole 94 located substantially in the center of the third planar member 92, and configured to engage a threaded rod 95 having a first actuation end 96, a second clamping end 97 and a longitudinal axis “X.” The hole 94 in wall “w1” is located such that the threaded rod's 95 longitudinal axis “X” may intersect a line created by the joinder of the first and second planar members 86, 87.

The threaded rod's 95 first actuation ends 96 may have an actuator 98 to allow the rod 95 to be rotated by hand, or by using an appropriate driving tool. The threaded rod second clamping end 97 may have a clamp 99 attached that is configured to engage the outer surface 15 of the cylindrical structural member 2. Rotation of the rod actuation end 96 in a first direction causes the rod threads to engage the threads of the hole 94; thereby advancing the rod 95 and its associated clamping end 97 through the hole toward the line joining the first and second members 86, 87. Rotation of the actuation end 96 in a second direction causes the rod 95 and its associated clamping end 97 to move away from the line joining first and second members 86, 87.

When the connector 85 of this embodiment is slipped over the end of the cylindrical structural member 2 and positioned along the structural member 2 at a desired location, the rod actuation end 96 may then be rotated so that the clamp 99 engages the structural member 2 outer surface 15, thereby nesting the structural member between the inner surfaces 88, 89 of the first and second planar members 86, 87, and fixing the connector 85 to the cylindrical structural member 2 both axially and rotationally.

The clamp 99 may comprise a flat surface 100, or its surface may be curved to more closely conform to the cylindrical surface 15 of the structural member 2.

The connector 85 of this embodiment may incorporate an additional fourth side member 101 positioned between the first and third side members 86, 92, and a fifth side member 102 positioned between the second and third side members 87, 92. These additional members may reduce the overall size of the connector 85, while still providing sufficient internal clearance to accommodate the largest anticipated size cylindrical structural member 2. Use of the additional side members also may provide a more aesthetically pleasing external appearance to the connector 85. It should be appreciated that the above described side members may comprise surfaces that are not substantially planar, as long as they provide the requisite clamping engagement of the cylindrical structural member 2, while providing at least one planar outer surface to which a standard hardware piece may be attached.

The planar members of this embodiment may be configured to incorporate a variety of connecting recesses to enable easy installation of existing hardware pieces, and they may also be configured to include one or more butt hinges 103 as may be appropriate.

In an alternative embodiment illustrated in FIG. 20, the third planar surface 92 may comprise a shouldered region 104 having a recess 105 into which a corresponding shoulder 106 of the clamp 99 may fit, in order to allow maximum retraction of the clamp within the connector 85, which may reduce the connector's overall size. Threaded hole 94 in wall “w1” may reside in an extension portion 107 to provide a larger threaded interaction surface with threaded rod 95 within recess 105.

FIGS. 21 and 22 show the connector of FIGS. 19 and 20 in which the connection between the first and fourth planar members 86, 101 comprises a hinge 108 having a hinge axis “Y” generally parallel to a longitudinal axis of the cylindrical support member 2, and the connection between the second and fifth planar members comprises a screwed connection 109. In this embodiment the first and second planar members 86, 87 form a first half 110 of connector 111, and the third, fourth and fifth planar members 92, 101, 102, form a second half 112 of the connector 111. The first and second halves 110, 112 are rotatable with respect to each other about the hinge axis “Y.” This embodiment differs from the embodiments of FIGS. 19 and 20, in which the connector 85 must be slipped over one end of the structural member 2 and then slid along the member 2 to the desired point of fixation. The connector 111 of FIGS. 21 and 22 may be applied directly to the desired point of fixation by opening the halves 110, 112 about the hinge axis “Y.” slipping the halves over the structural member 2, and closing the hinge. This configuration is particularly useful in instances where it is not possible to slide the connector along the structural member, such as where a shelving unit has already been constructed, and where it would be impractical to take the system apart.

The connector halves 110, 112 may be fixed using a screwed connection 109, or other suitable fastening arrangement. In all other respects the connector 111 of FIGS. 21 and 22 is same to the connector 85 of FIGS. 19 and 20.

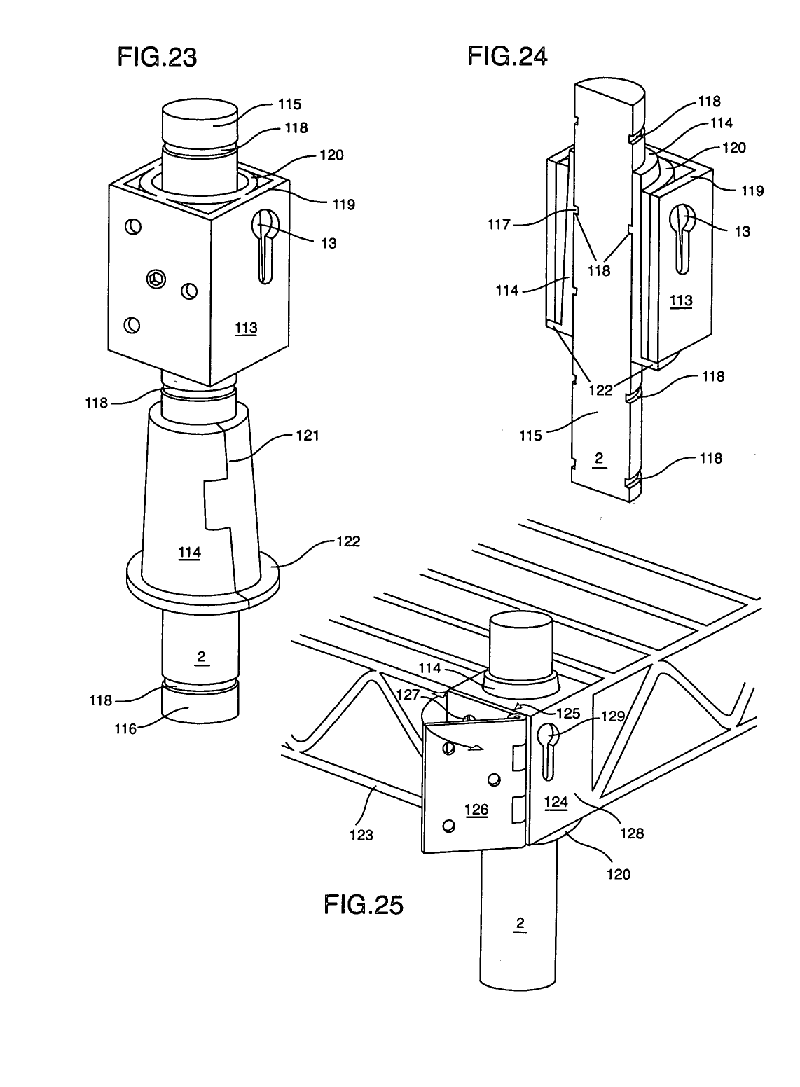

FIG. 23 and FIG. 24 show an embodiment of the connector 113, which contains all the described characteristics of connector 1 of FIG. 1, but which attaches to the cylindrical structural member 2 using a complementary wedge arrangement. FIG. 23 shows the connector 113 disengaged from the structural member 2 and FIG. 24 shows a cross-sectional view of the same arrangement with the connector 113 engaged with the structural member. Wedge member 114 has seam 121, which divides the wedge member in half and allows the wedge member 114 to be fit onto the outer surface of the structural member 2 between upper portion 115 and lower portion 116. The wedge member 114 may be fixed to the structural member 2 by one or more tabs 117 that may fit into a corresponding annular groove 118 formed in the structural member 2.

Connector 113 may comprise a box-shaped outer surface 119 having one or more substantially planar exterior connecting surfaces, and a wedge-shaped inner surface 120 configured to correspond to wedge member 114, so that when the connector 113 is slid over the end of the structural member 2, the corresponding wedges 120, 114 engage to fix the connector 104 and structural member 2 axially.

Wedge member 114 may further comprise a lip 122 at the bottom of the wedge member 114 to allow for precise vertical positioning of the connector 113 along the structural member 2. For attaching side panels to doors, particularly where such panels or doors are prefabricated, multiple connectors 113 are used to support each panel/door, and thus these connectors 113 should be fixed in the same vertical position along multiple structural members 2 to obtain a level positioning of the panel or door. The lip 122 at the bottom of wedge 114 allows the connector 113 to be placed at a consistent distance from groove 118 so that all corresponding connectors 113 holding a similar elements (side panel, door, etc.) may be placed at the same relative height. Existing wedge-type arrangements have no such lip 122 or other stop element, and thus it can be very difficult to ensure that all corresponding connectors are placed at the same height (since up to a quarter inch difference in vertical positioning may result from simply pressing the cone member harder into the wedge member). Such differences may be of little importance when assembling a shelf unit by itself; however, precise positioning is important where side panels or doors are to be mounted to the structural member. The lip 122 allows precise pre-placement of the connector with respect to the groove 118, regardless of the amount of force placed on the cone element, and thus guarantees proper alignment of the door or side panel on the structural member 2. Other types of stop element such as knobs, screws, metal posts or other suitable stop element inserted into the wedge member 114 may be used to perform the same function as lip 122 without changing the spirit of the invention.

Although not illustrated, and as with the previously disclosed embodiments, it is clear that connector 113 may incorporate a hinge element to allow the connector to be installed at any location along the structural member that contains a corresponding wedge member 101.

FIG. 25 shows the connector of FIG. 23 further comprising an integral shelf member 123. The connector 124 of this embodiment comprises a corner element of shelf member 123, and also has a first outer side surface 125 to which a butt hinge 126 is attached using machine screws 127 or other suitable fastening device. Connector 122 may also comprise a second outer side surface 128 having a recess 129 suitable for the installation of a side panel member (not shown) using, in this particular illustration, a pin-and-ball fastener. Connector 122 may be fixed to cylindrical structural member 2 using the wedge arrangement described above for connector 113 of FIG. 23 and FIG. 24, or it may be configured to engage the cylindrical structural member in any of the manners described above in relation to the connectors of FIGS. 1-22. Although the shelf member 123 of this embodiment is illustrated as attaching to only a single connector 124, it will be appreciated that a plurality of connectors may be integrated into the shelf member 123 as appropriate to the particular application.

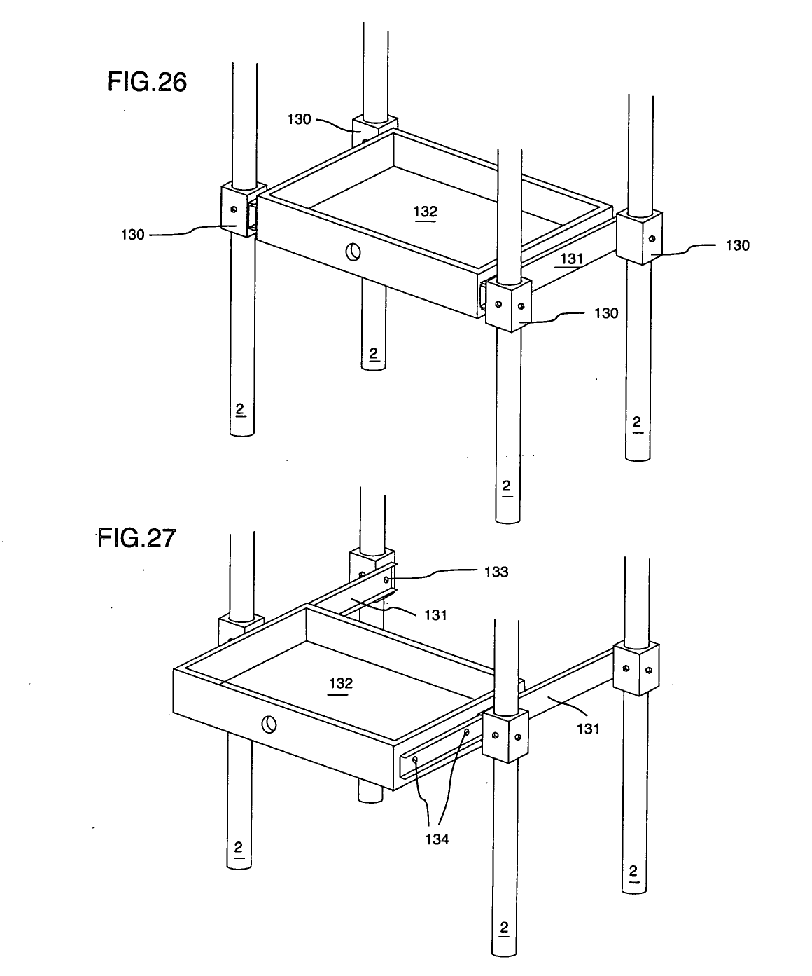

FIG. 26 shows a system of two connector pairs 130, attached to respective cylindrical structural members 2, wherein each connector 130 is attached to an opposite end of a drawer guide 131, where drawer guide 131 guides the opening and closing of drawer 132.

FIG. 27 shows the drawer-connecting system of FIG. 26, with drawer 132 in the open position, and showing the drawer guide 131 attached to the drawer using screws 133 and the drawer 132 attached to the drawer guide 131 using screws 134.

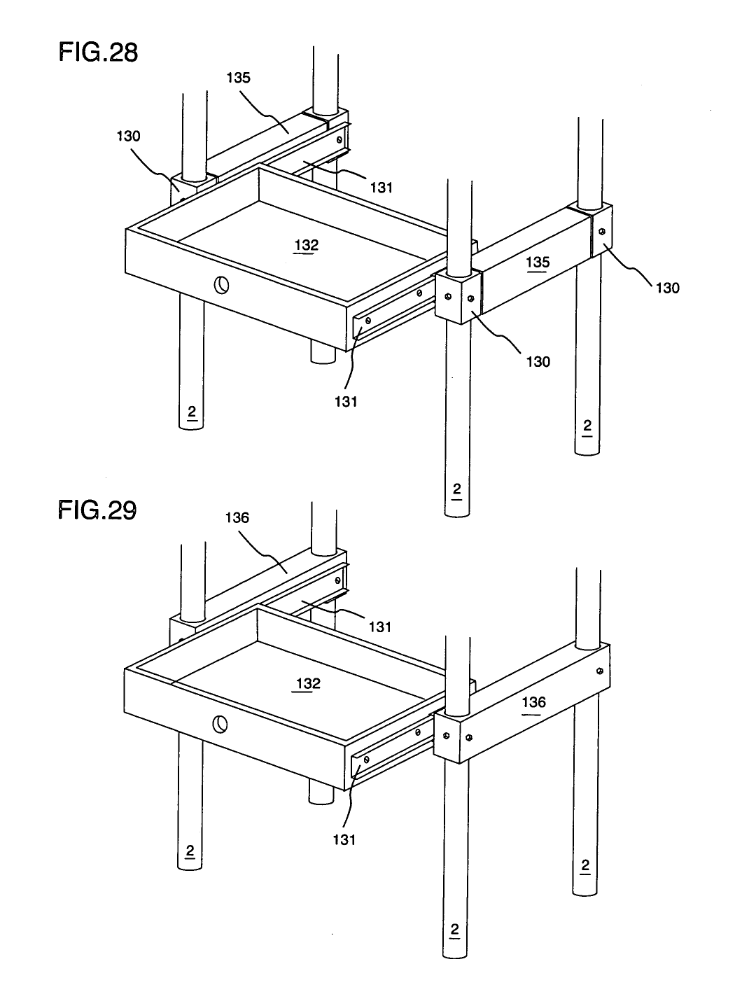

FIG. 28 shows the drawer-connecting system of FIG. 27, in which the connectors 130 of each connector pair are themselves connected by an extension member 135. This extension member 135 provides a large planar surface to which drawer guide 131 may be attached. Extension member 135 also provides additional stability to the connectors 130, preventing them from rotating around their respective structural members 2.

FIG. 29 shows the drawer-connecting system of FIG. 27, in which two connectors are comprised within a unitary connecting piece 136. On such unitary connecting piece 136 may be installed on either side of the drawer 132. Unitary connecting piece 136 may comprise two or more connectors consisting of any one or more of the embodiments illustrated in FIGS. 1-24 above. The unitary connecting piece 136 may be formed by welding an appropriately sized structural box member to one or more individual connectors, or the unitary connecting piece 136 may be formed from a single box.

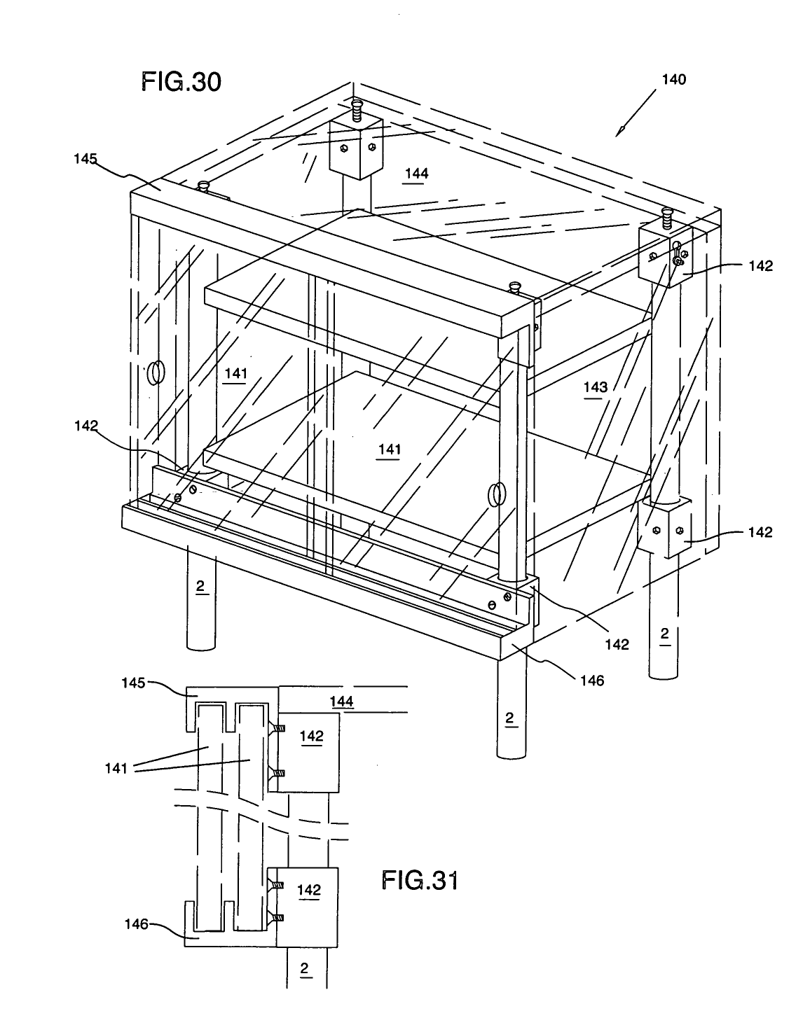

FIG. 30. shows a system of connector pieces used to construct an enclosed shelving unit 140 having a pair of sliding doors 141. In this embodiment eight connectors 142 are used to construct and enclose the shelving unit 140 with side and top panels 143, 144. Four of the eight connectors 1 are also used to support the sliding doors 141, using standard top and bottom tracks 145, 146 that may be screwed into pre-existing holes 121 in the connector pieces 142. In this embodiment, the shelves and cylindrical structural members 2 are fixed to each other using the connector 1. Thereafter the top panel 144 is installed on connectors 142 having top cap members 142 as described in reference to FIG. 8.

FIG. 31 shows a side view of the enclosed shelving unit 140, showing the relative placement of top and bottom tracks 145, 146, sliding doors 141, and the attachment scheme for attaching the top and bottom tracks 145, 146 to the connectors 1.

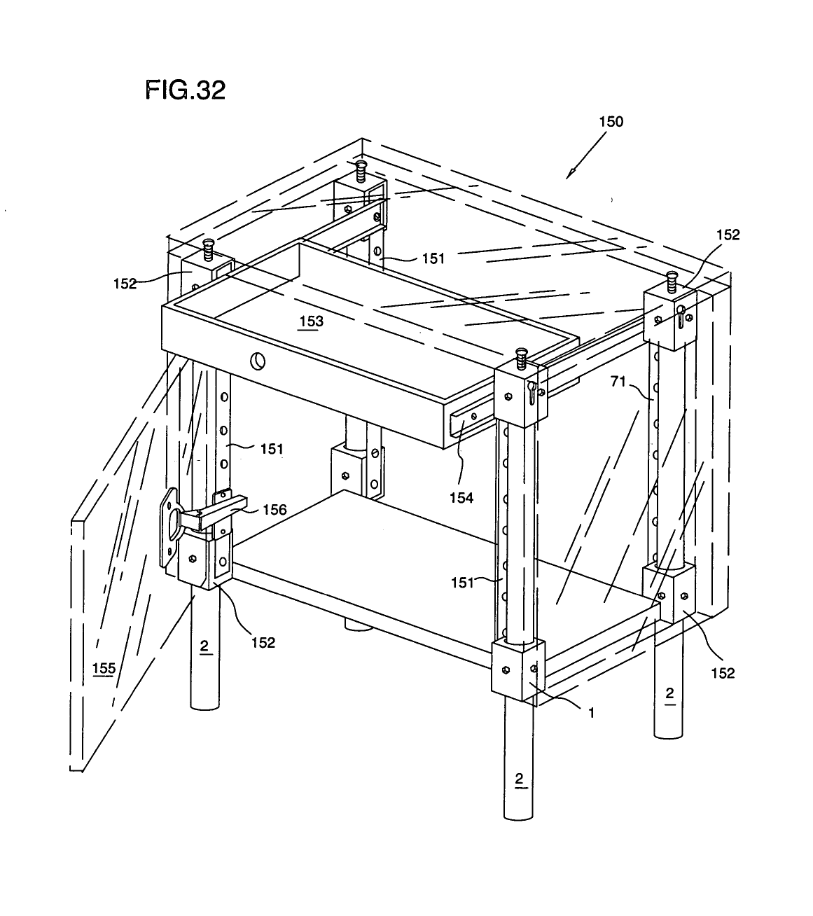

FIG. 32 shows a system of connector pieces that allow modular assembly of doors, drawers, shelves etc. to a shelving unit 150. Perforated metal flats 151 are mounted by means of the connectors 152 to the round vertical supports 2 and running parallel to them. On the perforated metal flats 151 a drawer 153 with two drawer guides 154 may be mounted. Alternatively, a door 155 may be connected to the perforated metal flats 151 by means of a full overlay hinge 156. Modular shelving units having evenly spaced holes are usually only found in wooden furniture where the holes are drilled into the sidewalls of cabinets. The connector allows for the mounting of the perforated metal flats 151 which in turn allow for the attachment of all standard hardware used for such modular systems.

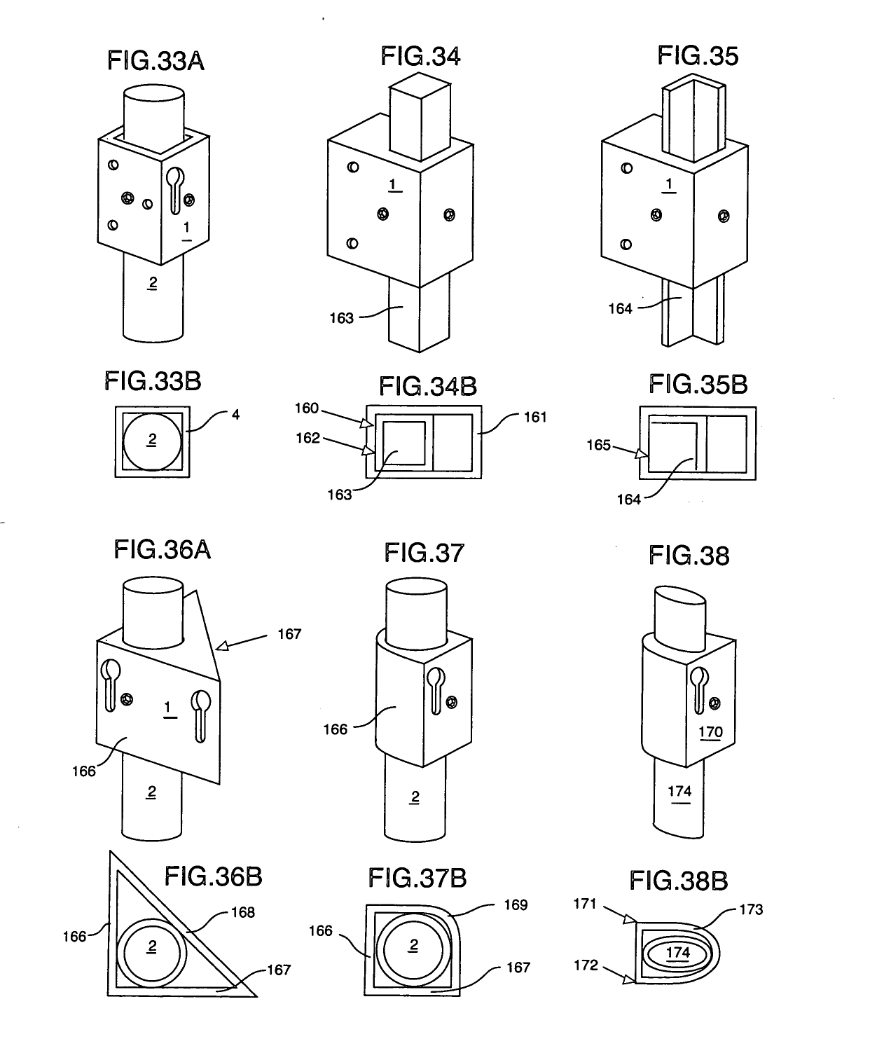

FIGS. 33A and 33B show a simplified embodiment of the connector 1 of FIG. 2 in which the inner cylindrical member 3 is eliminated, and instead the inner surface of the external box member 4 is sized to slideably accept the outer surface of the cylindrical structural member 2.

FIGS. 34A and 34B show an alternative embodiment of the connector 1 of FIG. 2 in which the inner surface 160 of external member 161 is sized to slideably accept at least a portion of the outer surface 162 of structural box member 163.

FIGS. 35 and 35B show an additional alterative embodiment of the connector of FIG. 2, where the structural support member comprises an angle or “L-shaped” beam 164, and the connector inner surface 165 is configured and sized to engage and retain the beam 164. Connectors with this configuration may be used to connect standard hardware to flat-sided members having planar dimensions too small to receive the attachment mechanisms of standard hardware such as for example standard butt or full overlay hinges. In this case the connector supplies an enlarged planar surface, which allows for the installation of the above standard hardware to such flat-sided members with small, planar dimensions.

FIGS. 36A and 36B show an alternative embodiment of the connector of FIG. 2, in which the first and second outer side surface members 166, 167 are joined by a third outer side surface member 168 which is substantially planar. The first and second outer side surface members 166, 167 may be oriented substantially perpendicular with respect to each other, so that the first, second and third side members join to form an external shape of the connector 1 which is generally triangular when viewed along the axis of the cylindrical structural member 2.

FIGS. 37A and 37B show a further alternative embodiment of the connector of FIG. 36A and FIG. 36B, in which the third side member 169 is curved.

FIGS. 38A and 38B show an alternative embodiment of the connector of FIG. 37, comprising only one substantially planar outer side surface member 170. The outer side surface member 170 has first and second ends 1781, 172 that are joined by a rounded outer side surface member 173, which also surrounds an elliptical structural member 174.

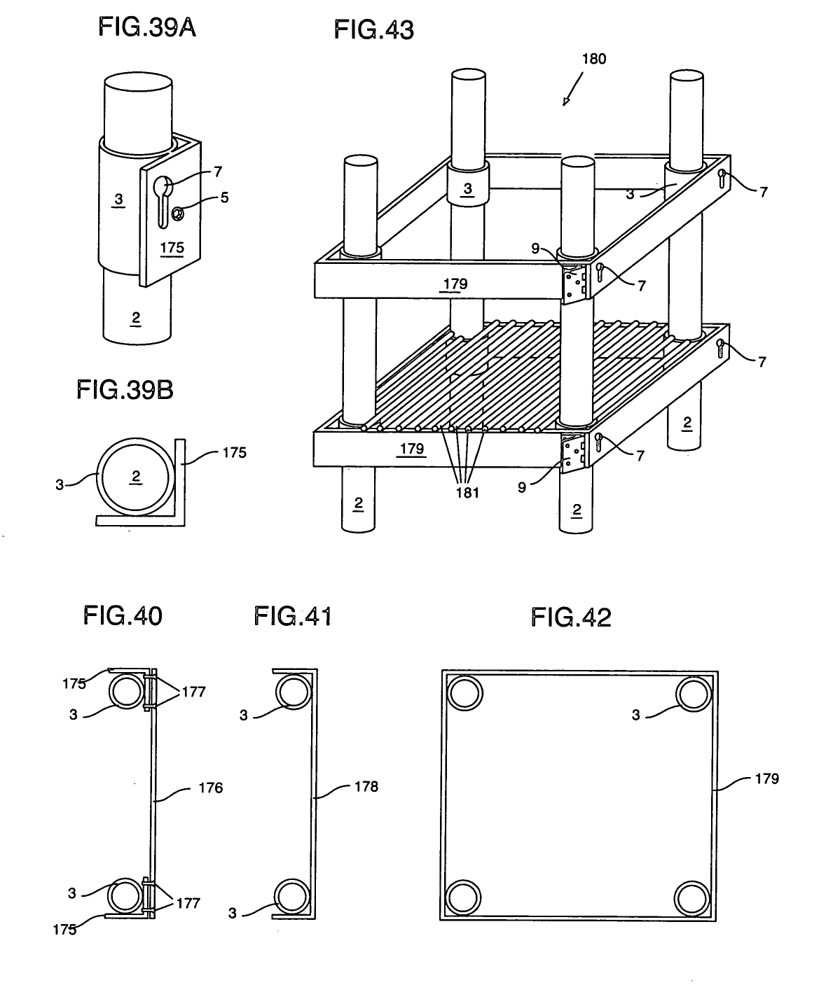

FIGS. 39A and 39B show an alternative embodiment of the connector of FIG. 1, in which the box-shaped exterior surface 4 of FIG. 1 is replaced by an L-shaped exterior surface 175. The design of this embodiment may provide a connector that is lighter and less expensive, while still providing an appropriate attachment surface to connect to various standard hardware pieces. FIG. 40 shows a connecting bar 176 attached to two opposing connectors 175 using machine screws 177, although any appropriate fastening mechanism known in the art may be used to effectuate this attachment. In an alternative embodiment, illustrated in FIG. 41, the two connectors and the connecting bar of FIG. 40 may be formed as an integral and unitary connecting bar 178. A further alternative embodiment, shown in FIG. 42, comprises four connectors 175 and four connecting bars which are formed into a single unitary, connecting piece 179. This unitary connecting piece 179 may be configured to receive a standard butt hinge 9 (FIG. 43), or other attachment mechanisms, such as a keyhole attachment 7, to allow for the attachment of doors or panels to the connecting piece 179. The connecting piece 179 may alternatively be provided with a shelf surface, shown in FIG. 43 as a series of parallel rods 181.

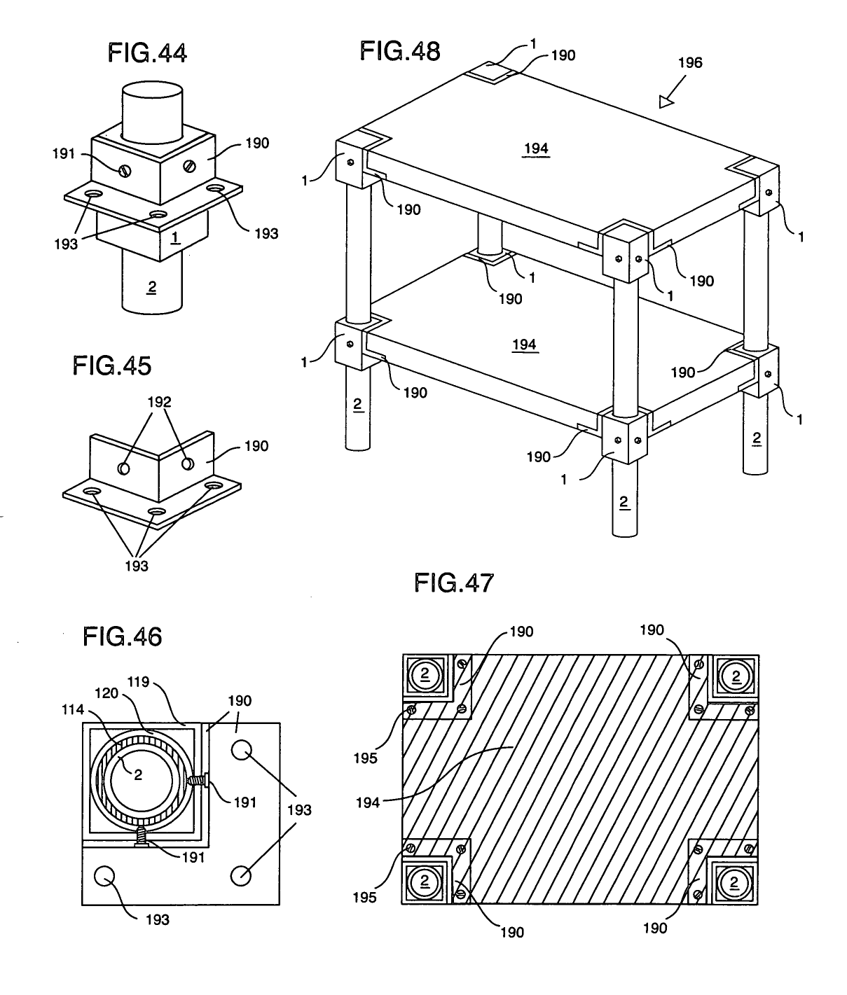

FIG. 44 and FIG. 46 show a perspective and plan view, respectively, of the connector 1 of FIG. 1 with a shelf bracket 190 attached by means of two machine screws 191 that pass through the holes 192 as seen in FIG. 45. The shelf bracket 190 has three holes 193 which allow for the attachment of a shelf 194 (shown hatched) by means of screws 195 as shown in FIG. 47. FIG. 48 reveals a shelving unit 196, which employs the shelf brackets 190 and the shelves 194. The advantage of being able to use a shelf bracket 190 in conjunction with the connector 1 is that it allows the attachment of shelves of all dimensions to the cylindrical member 2. The connector 1 in conjunction with the shelf bracket 190 therefore allows for more dimensional flexibility for the shelving unit 195.

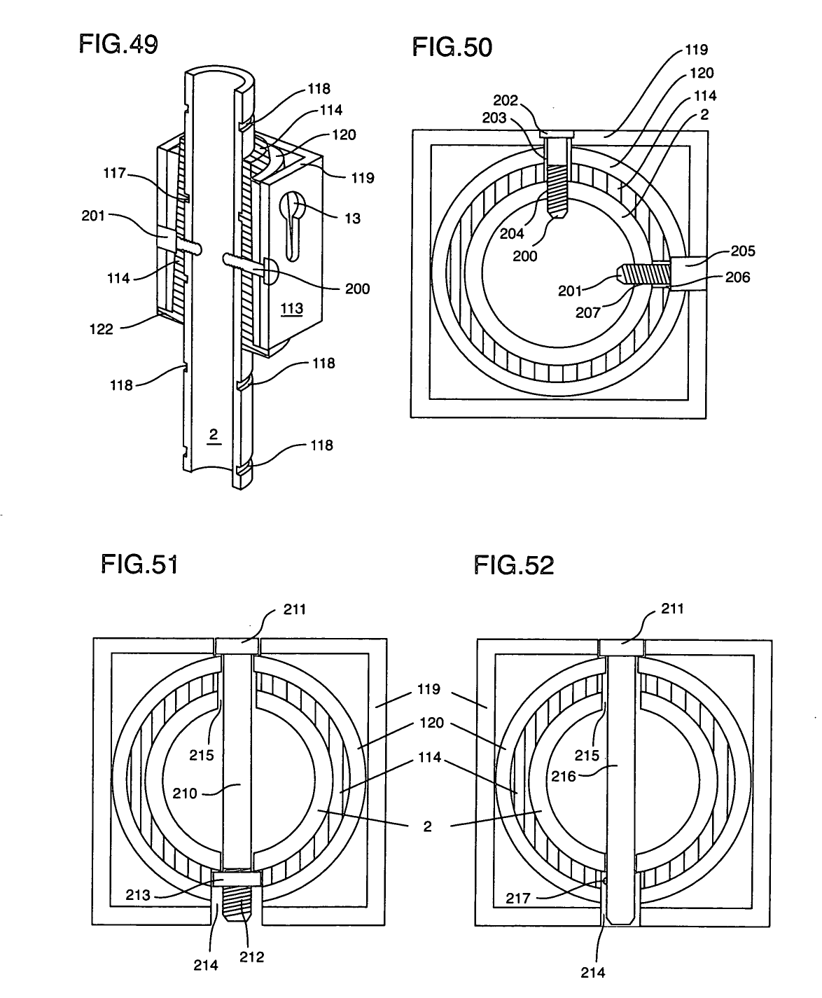

FIG. 49 through FIG. 54 show several variations to keep the connector 1 from rotating around the cylindrical member 2 and to fix the height of the connector 1 more precisely along the cylindrical member 2. One improvement already described in the text accompanying FIG. 23 and FIG. 24 is the lip 122 at the bottom of wedge 114 that allows the connector to be placed at a consistent distance from groove 118 so that all corresponding connectors holding a similar member (side panel, door, etc.) may be placed at the same relative height. The additional improvements described in FIG. 49 through FIG. 54 are specific to this invention as well. They are several variations to keep the connector 1 from rotating around the cylindrical member 2.

FIG. 49 through FIG. 52 show variations that keep the connector 113 from rotating around or sliding up and down the cylindrical member 2. These variations are illustrated in connection with the complementary wedge arrangement that is described in FIG. 23 through 25. FIG. 49 shows a cross-sectional view of the same arrangement with the connector 113 engaged with the structural member 2 as in FIG. 24 with the addition of two machine screws 200 and 201, which keep the connector 113 from rotating around the structural member 2.

FIG. 50 shows how the machine screws 200 and 201 intersect with the connector's 113 box-shaped outer surface 119, the wedge-shaped inner surface 120, the corresponding plastic wedge member 114 and the structural member 2. The machine screw 200 is a standard shoulder screw with a short, flat head 202, which is inlayed in the outer surface 119 and whose thread 204 clears the inner surface 120 and the wedge member 114 by a distance 203, and only engages in a threaded opening in the structural member 2. The gap 203 is prevents the thread 204 from accidentally engaging the inner surface 120 and the wedge member 114. This arrangement is easy to engage because it only touches in the above-described two places pulling the connector 113 tightly to the structural member 2. The machine screw 201 has a long head 205 which when the screw is tightened pushes against the wedge member 114 and whose thread 207 engages with the structural member 2. In this arrangement the fastening of the connector 113 takes place by pushing the wedge-member against the structural member 2. Again there is a gap 206 between the wedge member 114 and the thread 207.

FIG. 51 a long shoulder screw 210, which engages the opposite side of the structural member 2 by means of a nut 213 and thread 212 arrangement. An opening 214 that fits the nut 213 has been cut into the outer surface 119, the inner surface 120 and the wedge member 114 allowing the nut to push against the structural member 2. And the head 211 pushes against the outer surface 120. This arrangement is structurally stronger than the arrangements described in the text accompanying FIG. 50. It also has a gap 215, which helps in the easier insertion of the screw 210.

FIG. 52 shows a clevis style pin 216 whereby the nut and bolt configuration of FIG. 51 is replaced by a mechanism that when the pin 216 is pushed in or pulled out hard a steel ball 217 retracts. With this arrangement the connector 113 is very quickly attached to and disengaged from the structural member 2.

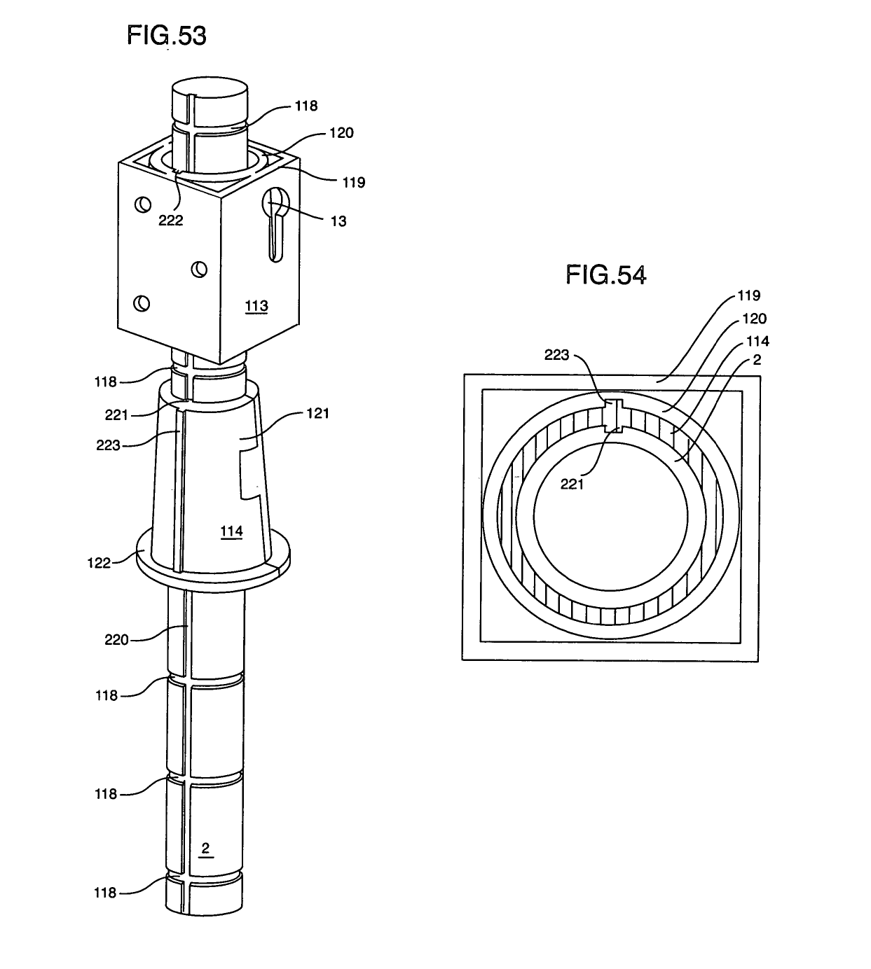

FIG. 53 shows a perspective view and FIG. 54 a cross-sectional view of an additional tongue and groove arrangement keeps the connector 113 from rotating around the structural member 2 when the wedge-type arrangement is engaged. For this, one groove 220 has been cut into the structural member's 2 surface along its vertical axes, which fits a tongue 221 located on the inside of the wedge member 114 along its vertical axes. Another groove 222 is located on the inside of the inner surface 120 along its vertical axes as well, which fits a tongue 223 located on the outside of the wedge member 114 along its vertical axes. When the connector 113 is pushed down onto the wedge-member 114 with the two tongues and grooves aligned the Connector will be prevented from rotating around the structural member 2.

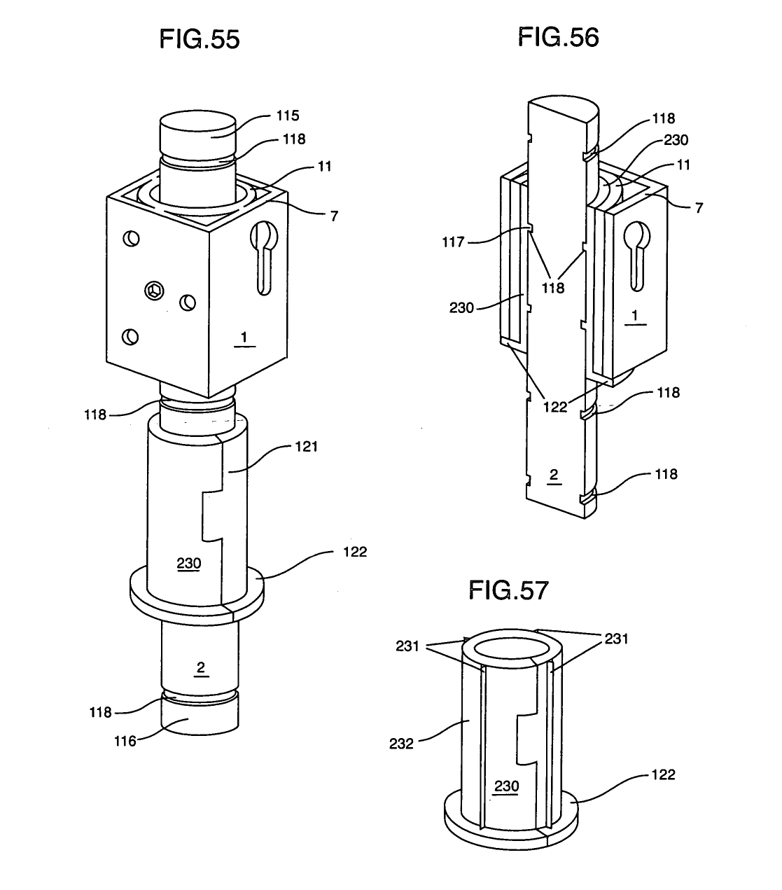

FIG. 55 and FIG. 56 show an embodiment of the connector, which attaches to the cylindrical structural member 2 using a cylindrical insert 230. FIG. 55 shows the connector 1 disengaged from the structural member 2 and FIG. 56 shows a cross-sectional view of the same arrangement with the connector 1 engaged with the structural member 2. The cylindrical insert 230, made from plastic or any other suitable materials, has a seam 121 as in FIG. 23, which divides the insert 230 in half and allows the insert 230 to be fit onto the outer surface of the structural member 2 between upper portion 115 and lower portion 116. The insert 250 may be fixed to the structural member 2 by one or more tabs ( in this FIG. 56 two tabs) 117 that may fit into a corresponding annular groove 118 formed in the structural member 2.

Connector 1 may comprise a box-shaped outer surface 7 as in FIG. 1 having one or more substantially planar exterior connecting surfaces, and a cylindrical inner surface 11 as in FIG. 1 with the difference to FIG. 1 that it is configured first to correspond to the cylindrical insert 230, which then is configured to engage the structural member 2, so that when the connector 1 is slid over the end of the structural member 2, the cylindrical surfaces 11, 230 engage to fix the connector 1 and structural member 2 axially.

The cylindrical insert 230 further comprises a lip 122 as in FIG. 23 at the bottom of the insert 230 to allow for precise vertical positioning of the connector 1 along the structural member 2 and stopping the connector 1 from sliding through the insert 230. For attaching side panels to doors, particularly where such panels or doors are prefabricated, multiple connectors 1 are used to support each panel/door, and thus these connectors 1 should be fixed in the same vertical position along multiple structural members 2 to obtain a level positioning of the panel or door. The lip 122 at the bottom of insert 230 allows the connector to be placed at a consistent distance from groove 118 so that all corresponding connectors holding a similar member (side panel, door, etc.) may be placed at the same relative height. There are no cylindrical arrangements with such a lip or other stop element, and this arrangement makes it easy to ensure that all corresponding connectors are placed at the same height. The lip 122 allows precise placement of the connector with respect to the groove 118, regardless of the amount of force placed on the connector 1, and thus guarantees proper alignment of the door or side panel on the structural member. This precise placement of the connector relative to the structural member 2 was not achievable in previous wedge type fastening arrangements with inserts because one couldn't control how far down the shelf goes on the wedge. Other types of stop element such as knobs, screws, metal posts or other suitable stop element inserted into the insert 230 may be used to perform the same function as lip 122 without changing the spirit of the invention.

Although not illustrated, and as with the previously disclosed embodiments, it is clear that connector 1 may incorporate a hinge element or any other standard hardware as discussed in the previous drawings.

FIG. 57 shows the cylindrical insert 230 with long small wedges 231 on its outer surface 232 that when the inner surface 11 of the connector 1 is pushed over them will crease under that pressure and will make the fit between the insert 230 and the inner surface 11 of the connector 1 and ultimately between the structural member 2 and the connector 1 very tight.

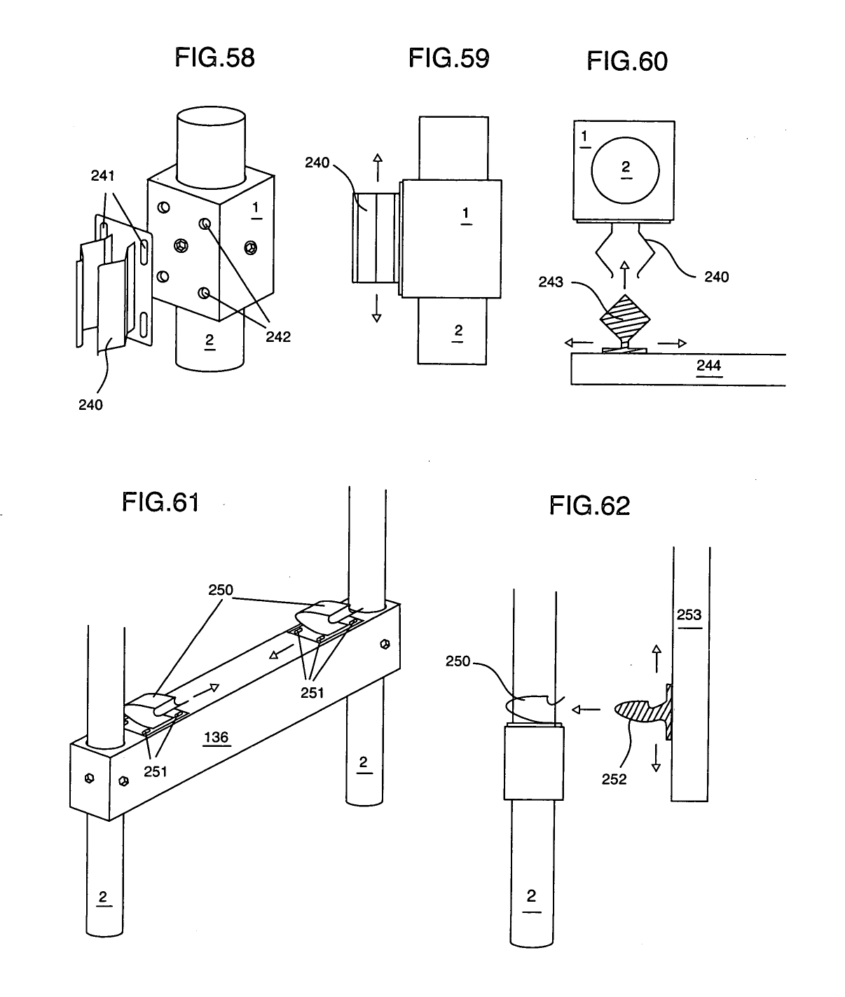

FIG. 58 through FIG. 62 show two variations of using clip on fasteners to attach a side panel. FIG. 58 shows the same connector 1 as in FIG. 2 with four threaded holes 242 ready to accept the receiving part 240 of a vertically adjustable clip on fastener. The receiving part 240 has four slots 241 through which it can be fastened to the connector 1. The slots 241 allow for the vertical adjustment of the receiving part 240 of a clip on fastener as shown in FIG. 59. The receiving part 240 is flexible to be able to engage the corresponding, horizontally adjustable insert 243 of the clip on fastener enabling the quick attachment of a side panel 244 to the connector 1. The vertical and horizontal adjustability of the receiving part 240 and the insert 243 of the clip on fastener allow for the fine tuned adjustment of the side panel's 244 connection to a shelving unit. This is of advantage if the shelf unit is slightly askew or if the vertical adjustment of shelves to the structural members 2 is slightly of register. The vertical and horizontal adjustability of any standard hardware in combination with the connector 1 renders the connector 1 even more versatile.

FIG. 61 shows a perspective view of the same unitary connecting piece 136 as in FIG. 29 with two horizontally adjustable receiving parts 250 of two clip-on fasteners. The receiving parts 250 have four slots 251 each through which they can be fastened to the unitary connecting piece 136. The slots 251 allow for the horizontal adjustment of the receiving parts 240 of clip on fastener as shown in FIG. 61. FIG. 62 show the side view of FIG. 61 with the receiving parts 250 ready to engage a side panel 253 by means of a corresponding, insert 252 of a clip on fastener. The side panel 253 in this arrangement when attached to the connector 1 will be flush with the connector 1, and vertically and horizontally adjustable with the aforementioned advantages of such an arrangement to a shelving unit.

The arrangements of clip-on fasteners in conjunction with connecting pieces 136 as described in FIG. 58 through 62 have an additional advantage. The clip-on fasteners' receiving ends 240 and 250 function like a funnel to receive the inserting parts 243 and 252 therefore, with the assistance of the connecting piece 136, making the attachment of side panels to for example a shelving unit comprising structural members 2 easier.

As is apparent, the connector of this invention can be modified in a number of ways other than as described in the foregoing and still be within the scope of the appended claims.

1. A connector for connecting a first element to a second element, said connector comprising:
a first surface for connecting to the first element, and having a first locking member,
a second surface for connecting to the second element, and having a second locking member,
wherein the first element is substantially planar and the second element is substantially non-planar, the first surface configured to engage the first element and the second surface configured to engage the second element, the first locking member configured to lock the first surface to the first element and the second locking member configured to lock the second surface to the second element.

2. The connector of claim 1, wherein the vertical axes of the first and second elements, which are going through the center of the bottom and top cross section of the first element and the second element are at least parallel.

3. The connector of claim 1, wherein the axes going through the center of the bottom and top cross section of the first and second surface are at least parallel to the axes going through the center of the bottom and top cross section of the first element and the second element.

4. The connector of claim 1, wherein the connector's first surface has a square, rectangular, triangular or L-shaped cross-section.

5. The connector of claim 1, wherein the connector's second surface has a round, elliptical, square, rectangular, triangular or L-shaped cross-section.

6. The connector of claim 1, wherein the connector's first surface has at least one planar aspect.

7. The connector of claim 6, wherein all planar aspects of the first surface are parallel to the first and second element.

8. The connector of claim 1, wherein at least 50% of the cross section of the second surface are congruent to and slightly bigger in diameter than the cross section of the second element.

9. The connector of claim 1, wherein the first locking member comprises at least one recess configured to receive a fastener to connect the first surface to the first element.

10. The connector of claim 1, wherein the second locking member comprises at least one clamp configured to engage the second element.

11. The connector of claim 10, wherein at least one clamp comprises at least one threaded rod having an actuation end and a clamping end, the actuation end comprising an actuator and the clamping end having an associated clamping face, the first and second faces comprising a wall there between, the wall having a threaded bore configured to receive the threaded rod between its actuation and clamping ends, the clamping face disposed between the first and second surfaces, wherein rotation of the at least one threaded rod in a first direction causes the associated clamping face to extend toward the second element to engage the second element, and rotation of the at least one threaded rod in a second direction causes the associated clamping face to retract from the second element.

12. The connector of claim 11, wherein the second element has a cross-section selected from the group of round or elliptical.

13. The connector of claim 1, wherein the first element is a piece of standard hardware, which attaches only to a planar surface.

14. The connector of claim 1, wherein the first element is a piece of standard hardware, which attaches only to a planar surface can attach to the second element, which is substantially non-planar by means of the connector.

15. The connector of claim 1, wherein the connector's first surface further can accept a first element such as for example a hinge member whereby the first surface and the first locking member comprises at least one recess configured to accept a fastener, the first locking member recess further configured to correspond with the hole in the hinge member, so that when the hinge member engages the first surface of the connector and the hinge and locking member holes are aligned to permit insertion of a fastener there through, tightening the fastener fixes the hinge member to the connector.

16. The connector of claim 1, wherein the connector's first surface is permanently attached to a first element such as for example a hinge member and whereby the first surface and one face of the hinge member are permanently fused.

17. The connector of claim 1, where the connector's first surface further comprises a recess configured to releasably engage a tongue latch of a door so that engagement of the tongue-latch and the recess connects the connector to the door.

18. The connector of claim 1, where the connector's first surface comprises a recess configured to engage a clip on fastener, which can engage a side panel to the first surface.

19. The connector of claim 1 wherein the second surface comprises first and second halves connected by a hinge, the first and second halves configured to assume a first unlocked position and a second locked position, wherein configuring the halves in the unlocked position allows the second element to be placed between the halves, and configuring the halves in the locked position engages the second element, coupling the second surface to the second element.

20. The connector of claim 19, wherein configuring the first and second halves in the locked position substantially prevents relative movement of the first and second halves along the second element.

21. The connector of claim 20, further comprising at least one fastener disposed within a wall of at least one of the first and second halves, so that when the halves are configured in the locked position, the fastener may be activated to engage the second element to prevent relative movement of the connector and the second element.

22. The connector of claim 21, further comprising at least one fastener disposed between, and operatively associated with, the first and second halves, such that tightening the fastener configures the halves to the closed locked position.

23. The connector of claim 22, wherein a standard piece of standard hardware, which attaches only to a planar surface can attach to the second element, which is substantially non-planar by means of the connector.

24. The connector of claim 1, wherein the first surface comprises a plurality of threaded and unthreaded holes, slots or other recesses, configured to allow the installation of a variety of first elements having different locking element arrangements.

25. The connector of claim 1, further comprising:
at least a second connector, with the same features as the connector of claim 1 whereas there is another second element with the same characteristics as the second element of claim 1, and
at least one support member having first and second ends,
wherein the said connector is associated with the support member's first end, said second connector is associated with the support member second end, and wherein the support member comprises an engaging surface configured to receive standard hardware and or panels that need large planar attachment surfaces.

26. The connector of claim 25, wherein the standard hardware pieces could be among others clip-on fasteners well suited to receive panels because of their funnel like arrangement, drawer guides, hatch door hardware.

27. The connector of claim 26, wherein said connector, said support member, and said second connector comprise a unitary piece.

28. The connector of claim 25, further comprising:
at least four said connectors, two said support members; and
at least one sliding drawer assembly, comprising a drawer and first and second opposing slide members; and
four vertical non-planar second elements;
wherein the first support member is configured to engage the first slide member, the said second support member is configured to engage the second opposing slide member, and the four connectors are configured to engage with the four vertical non-planar second elements, allowing the drawer to be connected via connector to the four second elements.

29. The connector of claim 1, further comprising:
at least four said connectors, two said support members; and
four vertical non-planar second elements; and
at least one shelf having four corners,
wherein each said connector is attached integrally or removably with each corner of at least one shelf.

30. The connector of claim 1, wherein the second locking member comprises a wedge member having a cone-shaped outer surface with a bottom lip and an inner surface that surrounds the second element, whereby the connector's second surface comprises a cone-shaped inner surface configured to engage the wedge member's outer surface and wherein when the connector second surface engages the wedge member outer surface the lip stops the connector at a specific point along the axes going through the centers of two cross sections of the second element and therefore maintains the position of the connector along the vertical axes of the second element.

31. The connector of claim 30, wherein the lip comprises an annular rim element configured to contact the bottom edge of the connector second surface.

32. The connector of claim 30, wherein the wedge members inner surface comprises at least one projection, and the second element comprises at least one recess configured to engage the wedge member projection, wherein when the wedge member inner projection is engaged with the second element's recess the wedge member is configured in a locked position preventing the wedge member from rotating around the vertical axes going through the centers of two cross sections of the second element.

33. The connector of claim 32, wherein the wedge member inner projection is a straight ridge and the second element's recess is a straight groove and the ridge and the grove are parallel to the vertical axes going through the centers of two cross sections of the second element.

34. The connector of claim 33, wherein the wedge members outer surface comprises at least one projection, and the connectors second surface comprises at least one recess configured to engage the wedge member projection, wherein when the wedge member outer projection is engaged with the second surface's recess the connector is configured in a locked position preventing the connector from rotating around the vertical axes of the second element.

35. The connector of claim 34, wherein the wedge member outer projection is a straight ridge and the connector's second surface recess is a straight groove and the ridge and the grove are parallel to the axes going through the centers of two cross sections of the second element.

36. The connector of claim 35, further comprising a hinge associated with the first surface.

37. The connector of claim 36, wherein the connector first surface comprises at least one recess configured to receive a fastener.

38. The connector of claim 1, wherein the second locking member comprises a cylindrical insert with a bottom lip and a cylindrical inner surface that surrounds the second element, whereby the connector's second surface comprises a cylindrical inner surface configured to engage the cylindrical insert's outer surface and wherein when the connector second surface engages the cylindrical insert outer surface the lip stops the connector at a specific point along the axes going through the centers of two cross sections of the second element and therefore maintains the position of the connector along the vertical axes of the second element.

39. The connector of claim 38, wherein the lip comprises an annular rim element configured to contact the bottom edge of the connector second surface.

40. The connector of claim 38, wherein the cylindrical insert's inner surface comprises at least one projection, and the second element comprises at least one recess configured to engage the cylindrical insert's projection, wherein when the cylindrical insert's inner projection is engaged with the second element's recess the cylindrical insert is configured in a locked position preventing the cylindrical insert from rotating around the vertical axes going through the centers of two cross sections of the second element.

41. The connector of claim 40, wherein the cylindrical insert's inner projection is a straight ridge and the second element's recess is a straight groove and the ridge and the grove are parallel to the vertical axes going through the centers of two cross sections of the second element.

42. The connector of claim 41, wherein the cylindrical insert's outer surface comprises at least one projection, and the connectors second surface comprises at least one recess configured to engage the cylindrical insert's projection, wherein when the cylindrical insert's outer projection is engaged with the second surface's recess the connector is configured in a locked position preventing the connector from rotating around the vertical axes of the second element.

43. The connector of claim 42, wherein the cylindrical insert's outer projection is a straight ridge and the connector's second surface recess is a straight groove and the ridge and the grove are parallel to the axes going through the centers of two cross sections of the second element.

44. The connector of claim 43, further comprising a hinge associated with the first surface.

45. The connector of claim 44, wherein the connector first surface comprises at least one recess configured to receive a fastener.

46. The connector of claim 38, wherein the insert's outer surface comprises small protrusions, which still allow the connector's second surface to be pushed over the insert but with more force because the protrusions get slightly jammed.

47. The connector of claim 46, wherein when the connector is engaged with the insert with the small protrusions this arrangement makes for a tight fit between the connector and the second element.

48. The connector of claim 1, further comprising a shelf bracket with at least two planer members, the first planar member is configured to engage with the first surface of the connector and the second planar member is configured to engage a shelf, wherein a plurality of shelf brackets in conjunction with a plurality of connectors are configured to attach a plurality of shelves to a plurality of non-planar second elements to form a shelving unit.

49. The connector of claim 48, wherein the shelf bracket is permanently fused to the first surface of the connector.

50. A connector for connecting a hardware member to a structural member, said connector comprising:
a first surface for connecting to the hardware member, and having a first locking member,
a second surface for connecting to the structural member, and having a second locking member,
wherein the hardware and structural members are substantially planar and each has a width, the first surface configured to engage the hardware member and the second surface configured to engage the structural member, the first locking member configured to lock the first surface to the hardware member and the second locking member configured to lock the second surface to the structural member, and wherein the hardware has at least one surface dimension that is greater than at least one surface dimension of the structural member.

51. The connector of claim 50, wherein the connector has a square, rectangular, or triangular cross-section.

52. The connector of claim 50, wherein the first locking member comprises at least one recess configured to receive a fastener.

53. The connector of claim 50, wherein the first locking member comprises at least one recess configured to receive a fastener to connect the first surface to the hardware member, and the second locking member is configured to engage the structural member.

54. The connector of claim 50, wherein the second locking member comprises at least one clamp configured to engage the structural member.

55. The connector of claim 54, wherein the at least one clamp comprises at least one threaded rod having an actuation end and a clamping end, the actuation end comprising an actuator and the clamping end having an associated clamping face, the first and second surfaces comprising a wall therebetween, the wall having a threaded bore configured to receive the threaded rod between its actuation and clamping ends, the clamping face disposed between the first and second surfaces, wherein rotation of the at least one threaded rod in a first direction causes the associated clamping face to extend toward the structural member to engage the structural member, and rotation of the at least one threaded rod in a second direction causes the associated clamping face to retract from the structural member.

56. A system of connectors for attaching at least one planar member to a plurality of non-planar members, comprising:
at least one planar member having a planar surface, the planar surface having at least first and second portions;
a plurality of non-planar members each having at least one non-planar surface;
a first connector for connecting the first planar member to a first non-planar member, the first connector comprising:
a first face for connecting to the first portion of the planar surface;
a second face for connecting to the first non-planar member's surface;
a second connector for connecting the planar member to a second non-planar member, the second connector comprising:
a first face for connecting to the second portion of the planar member's surface;
a second face for connecting to the second non-planar surface;
wherein when the first connector engages respective planar and non-planar members and the second connector engages respective planar and non-planar members, at least one planar member at least partially overlaps the plurality of non-planar members.

57. The system of connectors of claim 56, wherein the first and second connectors each comprises a hinge having at least one hinge face, and the first hinge face is configured to engage the first portion of the planar surface, and the second hinge face is configured to engage the second portion of the planar surface.

58. The system of connectors of claim 57, further comprising third and fourth connectors and a door panel having first and second ends, the first end having a tongue-latch mechanism, the third connector comprising a recess configured and arranged to engage the door panel tongue-latch, the fourth connector first face comprising a hinge member to connect to the door panel second end, wherein when the door panel is in the closed configuration the tongue-latch engages the recess in the third connector and the door panel overlaps at least a portion of the non-planar members.

59. A system of connectors for attaching a modular system of perforated members to a plurality of non-planar members comprising:
at least first and second planar perforated members each having first and second ends and each comprising a plurality of locking members located between said first and second ends;
a first connector for connecting a first element to a second element, comprising:
a first surface for connecting to the first element, and having a first locking member,
a second surface for connecting to the second element, and having a second locking member,
wherein the first element is substantially planar and the second element is substantially non-planar, the first surface configured to engage the first element and the second surface configured to engage the second element, the first locking member configured to lock the first surface to the first element and the second locking member configured to lock the second surface to the second element; and
at least a second connector for connecting a third element to a fourth element, comprising:
a third surface for connecting to the third element, and having a third locking member,
a fourth surface for connecting to the fourth element, and having a fourth locking member,
wherein the third element is substantially planar and the fourth element is substantially non-planar, the third surface configured to engage the third element and the fourth surface configured to engage the fourth element, the third locking member configured to lock the third surface to the third element and the fourth locking member configured to lock the fourth surface to the fourth element; and
wherein the first surface of the first connector is configured to engage at least one locking member of the first perforated member, the first surface of the second connector configured to engage at least one locking member of the second perforated member, and wherein the second surface of the first connector is further configured to engage the first non-planar member and the second fourth surface of the second connector is further configured to engage the second non-planar member to thereby mechanically couple the first and second planar perforated members to the first and second non-planar members.

60. The system of connectors of claim 59, wherein the locking members are further configured to receive at least one shelf member.
